(19) United States
(12) Patent Application Publication
(10) Pub. No.: US 2024/0265375 A1
(43) Pub. Date: Aug. 8, 2024

(54) PRODUCTION METHOD AND PRODUCTION SYSTEM FOR NON-FUNGIBLE TOKEN, REGISTRATION METHOD AND SYSTEM FOR UNIQUE IDENTIFIER, AND PRODUCTION METHOD FOR COMBINATION PRODUCT

(71) Applicants: WRAPTAG INC., Hyogo (JP); AI SHOJI CO., LTD., Hyogo (JP)

(72) Inventors: Yukio HARUNA, Hyogo (JP); Hitoshi TAKEUCHI, Hyogo (JP)

(73) Assignees: WRAPTAG INC., Hyogo (JP); AI SHOJI CO., LTD., Hyogo (JP)

(21) Appl. No.: 18/565,941

(22) PCT Filed: Sep. 28, 2022
(86) PCT No.: PCT/JP2022/036314

§ 371 Date: Nov. 30, 2023

(30) Foreign Application Priority Data
Sep. 28, 2021 (JP) 2021-158253

(51) Int. Cl. G06Q 20/36

(52) U.S. Cl. CPC G06Q 20/3678

(57) ABSTRACT

An object having a unique identifier is used for operations on tokens in a blockchain. The disclosed method is a production method executed by a system that produces a non-fungible token to be recorded on the blockchain. The production method includes: receiving a unique identifier possessed by an object; determining whether or not the received unique identifier is an already-registered unique identifier that has been registered in the system in advance; and generating a non-fungible token if the received unique identifier is determined to be the already-registered unique identifier.

### TECHNICAL FIELD

The present disclosure relates to a production method and system for non-fungible tokens, a registration method and system for unique identifiers, a production method for combination products, and the like. This application claims priority on Japanese Patent Application No. 2021-158253 filed on Sep. 28, 2021, the entire content of which is incorporated herein by reference.

### BACKGROUND ART

PATENT LITERATURE 1 discloses an object to which data used for calling a smart contract is given. The data given to the object includes data for identifying a non-fungible token (NFT).

CITATION LIST

### Patent Literature

PATENT LITERATURE 1: Japanese Laid-Open Patent Publication No. 2021-089640

### SUMMARY OF INVENTION

The work of giving data to objects may have a heavy load. For example, in PATENT LITERATURE 1, two-dimensional codes are given to objects, and therefore, work of heavy load, i.e., giving different two-dimensional codes to the objects, may be required.

In order to save the labor of giving data, the inventors of the present disclosure have come up with an idea that an object having a unique identifier in advance, such as an integrated circuit tag having a unique identifier, is used for operations on tokens on a blockchain, such as production of non-fungible tokens.

One aspect of the present disclosure is a production method for a non-fungible token to be recorded on a blockchain. The production method of the disclosure may include: receiving, by a non-fungible token production system, a unique identifier that is possessed by an object and is transmitted from a reader having read the unique identifier; and generating a non-fungible token by the production system having received the unique identifier.

Another aspect of the present disclosure is a production system for a non-fungible token to be recorded on a blockchain. The production system of the disclosure may be configured to execute a process including: receiving a unique identifier possessed by an object via a network; and generating a non-fungible token upon receiving the unique identifier.

Another aspect of the present disclosure is a registration method for a unique identifier. The registration method of the disclosure may include: receiving, by a system, via a network, a unique identifier possessed by an object; and registering the received unique identifier by the system as a unique identifier to be used for operations on a token on a blockchain.

Another aspect of the present disclosure is a system for operating tokens on a blockchain. The system of the disclosure may be configured to execute a process including: receiving a unique identifier possessed by an object via a network; and registering the received unique identifier as a unique identifier to be used for operations on a token on the blockchain.

Another aspect of the present disclosure is a production method for a combination product of an object, and a non-fungible token recorded on a blockchain. The combination product production method of the disclosure may include: preparing an object having a unique identifier; reading the unique identifier of the object with a reader; transmitting the unique identifier read by the reader, from the reader to a non-fungible token production system; and generating a non-fungible token associated with the unique identifier by the production system by using the unique identifier transmitted to the production system, thereby obtaining a combination product of the object, and the non-fungible token associated with the unique identifier of the object.

Another aspect of the present disclosure is a combination product. The combination product of the disclosure may include: an integrated circuit having a unique identifier; and a non-fungible token associated with the unique identifier of the integrated circuit.

Another aspect of the present disclosure is an integrated circuit having a unique identifier. In the integrated circuit of the disclosure, the unique identifier may be an already-registered unique identifier that has been registered in a system for operating tokens on a blockchain. The system may be configured to operate a token on the blockchain upon receiving a unique identifier that is the same as the already-registered unique identifier. The already-registered unique identifier may be used for operating the token in the system.

Another aspect of the present disclosure is an object. The object of the disclosure may include: an integrated circuit; and a code indicating data for accessing the system.

Another aspect of the present disclosure is a use method for using an integrated circuit having a unique identifier. The use method of the disclosure may include: reading the unique identifier of the integrated circuit with a reader; receiving the unique identifier transmitted from the reader, by a system for operating tokens on a blockchain; identifying a token associated with the unique identifier, by the system using the received unique identifier; and operating the identified token by the system.

Further details will be described later as an embodiment.

### BRIEF DESCRIPTION OF DRAWINGS

FIG. 1 is a schematic diagram showing a blockchain and an integrated circuit.

FIG. 2 shows a configuration of a system.

FIG. 3 shows a configuration of a server.

FIG. 4 is a schematic diagram showing a smart contract and a non-fungible token.

FIG. 5 is a flowchart of a procedure for utilizing an NFC tag.

FIG. 6 is a schematic diagram showing an example of a combination product.

FIG. 7 is a flowchart of an NFT registration process.

FIG. 8 is a schematic diagram showing an example of access to a system 10.

FIG. 9 is a schematic diagram showing a flow of a unique identifier.

FIG. 10 is a schematic diagram showing a flow of a unique identifier.

FIG. 11 is a schematic diagram showing an example of a combination product.

FIG. 12 is a flowchart of a unique identifier registration process.

FIG. 13 is a flowchart of a procedure for utilizing an IC tag.

FIG. 14 is a flowchart of a procedure for manufacturing a card.

FIG. 15 shows card manufacture data.

FIG. 16 illustrates a card identifier.

FIG. 17 illustrates card manufacture.

FIG. 18 shows a UID list.

FIG. 19 shows an NFT material data list.

FIG. 20 illustrates NFT generation.

FIG. 21 shows a UID list including token identifiers.

### DESCRIPTION OF EMBODIMENTS

### 1. Outlines of Production Method and System for Non-Fungible Tokens, Registration Method and System for Unique Identifiers, Production Method for Combination Products, Etc.

(A1) A method according to an embodiment is a production method for a non-fungible token to be recorded on a blockchain. The method includes: receiving, by a non-fungible token production system, a unique identifier that is possessed by an object and is transmitted from a reader having read the unique identifier; and generating a non-fungible token by the production system having received the unique identifier.

(A2) Generating the non-fungible token preferably includes generating the non-fungible token associated with the unique identifier, by using the received unique identifier.

(A3) Generating the non-fungible token associated with the unique identifier preferably includes recording correspondence data into the blockchain or a computer outside the blockchain. The correspondence data is preferably data indicating correspondence between the unique identifier, and a token identifier that is recorded on the blockchain in order to identify the non-fungible token.

(A4) Generating the non-fungible token preferably includes recording, on the blockchain, non-fungible token data constituting the non-fungible token.

(A5) The non-fungible token data preferably includes the unique identifier.

(A6) The non-fungible token data preferably includes data relating to an attachment object to which the object is attached.

(A7) Preferably, the production method further includes determining, by the production system, based on the received unique identifier, whether or not to generate the non-fungible token. The non-fungible token is preferably generated when determination as to generate the same is made.

(A8) Preferably, the production method further includes determining, by the production system, whether or not the received unique identifier is an already-registered unique identifier that has been registered in the production system in advance. The non-fungible token is preferably generated if the received unique identifier is determined to be the already-registered unique identifier.

(A9) The object preferably includes an integrated circuit. The unique identifier is preferably a unique identifier of the integrated circuit.

(A10) The object preferably includes a radio frequency identification (RFID) device. The unique identifier is preferably a unique identifier of the radio frequency identification device.

(A11) The radio frequency identification device is preferably a radio frequency identification tag.

(A12) The reader is preferably a communication device that receives the unique identifier transmitted from the object, through non-contact communication with the object.

(A13) The object preferably includes a read only memory. The unique identifier is preferably stored in the read only memory.

(A14) The object preferably includes a non-volatile memory. The unique identifier is preferably stored in the non-volatile memory.

(A15) A system according to the embodiment is a production system for a non-fungible token to be recorded on a blockchain. The production system is configured to execute a process including: receiving a unique identifier possessed by an object via a network; and generating a non-fungible token upon receiving the unique identifier.

(A16) Generating the non-fungible token preferably includes generating the non-fungible token associated with the unique identifier, by using the received unique identifier.

(A17) Preferably, the process further includes determining, based on the received unique identifier, whether or not to generate the non-fungible token. The non-fungible token is preferably generated when determination as to generate the same is made.

(A18) Preferably, the process further includes determining whether or not the received unique identifier is an already-registered unique identifier that has been registered in the production system in advance. The non-fungible token is preferably generated if the received unique identifier is determined to be the already-registered unique identifier.

(A19) A method according to the embodiment is a registration method for a unique identifier. The method includes: receiving, by a system, via a network, a unique identifier possessed by an object; and registering the received unique identifier as an already-registered unique identifier to be used for operations on a token on a blockchain.

(A20) Preferably, the method further includes executing a settlement process for paying a registration fee of the unique identifier.

(A21) The operations on a token preferably include at least one of: generation of the token; transmission of the token; and reception of the token.

(A22) The operations on a token preferably include generation of a non-fungible token associated with the unique identifier.

(A23) A system according to the embodiment is a system for operating a token on a blockchain. The system is configured to execute a process including: receiving a unique identifier possessed by an object via a network; and registering the received unique identifier as an already-registered unique identifier to be used for operations on the token on the blockchain.

(A24) A method according to the embodiment is a production method for a combination product of an object, and a non-fungible token recorded on a blockchain. The method includes: preparing an object having a unique identifier; reading the unique identifier of the object with a reader; transmitting the unique identifier read by the reader, from the reader to a non-fungible token production system; and generating a non-fungible token associated with the unique identifier by the production system by using the unique identifier transmitted to the production system, thereby obtaining a combination product of the object, and the non-fungible token associated with the unique identifier of the object.

(A25) A combination product according to the embodiment includes: an integrated circuit having a unique identifier; and a non-fungible token associated with the unique identifier of the integrated circuit.

(A26) Preferably, the combination product further includes an attachment object to which the integrated circuit is attached. The non-fungible token preferably includes data relating to the attachment object.

(A27) An integrated circuit according to the embodiment is an integrated circuit having a unique identifier. The unique identifier is an already-registered unique identifier that has been registered in a system for operating a token on a blockchain. The system is configured to operate a token on the blockchain upon receiving a unique identifier that is the same as the already-registered unique identifier. The already-registered unique identifier is used for operations on the token in the system.

(A28) The operations on the token preferably include at least one of: generation of the token; transmission of the token; and reception of the token.

(A29) An object according to the embodiment includes: the integrated circuit described in the above (A27) or (A28); and a code indicating data for accessing the system.

(A30) The data for accessing the system is preferably a URL of a server included in the system.

(A31) A method according to the embodiment is a use method for using an integrated circuit having a unique identifier. The use method includes: reading the unique identifier of the integrated circuit with a reader; receiving the unique identifier transmitted from the reader, by a system for operating tokens on a blockchain; identifying a token associated with the unique identifier, by the system using the received unique identifier; and operating the identified token by the system.

(B1, B2) A method according to the embodiment is a production method executed by a system for producing a non-fungible token to be recorded on a blockchain. The method includes: receiving a unique identifier possessed by an object; determining whether or not the received unique identifier is an already-registered unique identifier that has been registered in the system in advance; and generating a non-fungible token if the received unique identifier is determined to be the already-registered unique identifier. Generating the non-fungible token is executing, by the system, at least one of processes (1) and (2) as follows. Preferably, the object includes an integrated circuit, and the unique identifier is a unique identifier of the integrated circuit.
(1) A process including generating a non-fungible token having the unique identifier.
(2) A process including generating a non-fungible token. Such generating the non-fungible token includes recording, on the blockchain or a computer outside the blockchain, correspondence between the non-fungible token and the unique identifier.

(B3) Preferably, the method further includes identifying generation data to be used for generating the non-fungible token, from among a plurality of material data that are possessed by the system to be used for generating the non-fungible token. Preferably, the generation data is identified based on the received unique identifier, with reference to correspondence data between the unique identifier and the generation data, or identified based on data that is received by the system to identify the generation data. The non-fungible token is preferably generated by using at least the identified generation data.

(B4, B5) A system according to the embodiment is a production system for a non-fungible token to be recorded on a blockchain. The system is configured to execute a process comprising: receiving a unique identifier possessed by an object; determining whether or not the received unique identifier is an already-registered unique identifier that has been registered in the production system in advance; and generating a non-fungible token having the unique identifier if the received unique identifier is determined to be the already-registered unique identifier. Generating the non-fungible token is executing, by the production system, at least one of processes (1) and (2) as follows. Preferably, the object includes an integrated circuit, and the unique identifier is a unique identifier of the integrated circuit.
(1) A process including generating a non-fungible token having the unique identifier.
(2) A process including generating a non-fungible token. Such generating the non-fungible token includes recording, on the blockchain or a computer outside the blockchain, correspondence between the non-fungible token and the unique identifier.

(B6) Preferably, the process further includes identifying generation data to be used for generating the non-fungible token, from among a plurality of material data that are possessed by the system to be used for generating the non-fungible token. Preferably, the generation data is identified based on the received unique identifier, with reference to correspondence data between the unique identifier and the generation data, or identified based on data that is received by the system to identify the generation data. The non-fungible token is preferably generated by using at least the identified generation data.

(B7, B8) A method according to the embodiment is a registration method executed by a system for registering a unique identifier. The system is configured to execute a generation process for generating a non-fungible token to be recorded on a blockchain. The registration method includes: receiving a unique identifier possessed by an object via a network; and registering the received unique identifier as an already-registered unique identifier. The system is configured to execute the generation process upon receiving a unique identifier that is the same as the already-registered unique identifier. The generation process includes at least one of processes (1) and (2) as follows. The unique identifier is preferably a unique identifier of an integrated circuit included in the object.
(1) A process including generating a non-fungible token having the unique identifier.
(2) A process including generating a non-fungible token. Such generating the non-fungible token includes recording, on the blockchain or a computer outside the blockchain, correspondence between the non-fungible token and the unique identifier.

(B9, B10) A system according to the embodiment is configured to execute a process including: receiving a unique identifier possessed by an object, via a network; registering the received unique identifier as an already-registered unique identifier; and generating a non-fungible token to be recorded on a blockchain, upon receiving a unique identifier that is the same as the already-registered unique identifier. Generating the non-fungible token is executing at least one of processes (1) and (2) as follows. The unique identifier is preferably a unique identifier of an integrated circuit included in the object.
(1) A process including generating a non-fungible token having the unique identifier.
(2) A process including generating a non-fungible token. Such generating the non-fungible token includes recording, on the blockchain or a computer outside the blockchain, correspondence between the non-fungible token and the unique identifier.

(B11, B12) A method according to the embodiment is a production method for a combination product of an object and a non-fungible token recorded on a blockchain. The production method includes steps executed by a non-fungible token production system. The steps include: receiving a unique identifier possessed by an object; determining whether or not the received unique identifier is an already-registered unique identifier that has been registered in the non-fungible token production system in advance; and generating a non-fungible token if the received unique identifier is determined to be the already-registered unique identifier. Generating the non-fungible token is executing at least one of processes (1) and (2) as follows.
(1) A process including generating a non-fungible token having the unique identifier.
(2) A process including generating a non-fungible token. Such generating the non-fungible token includes recording, on the blockchain or a computer outside the blockchain, correspondence between the non-fungible token and the unique identifier.

The combination product includes the object and the non-fungible token. The unique identifier is preferably a unique identifier of an integrated circuit included in the object.

(C1) A method according to the embodiment may include recording, in a memory of an integrated circuit having a unique identifier, data to be used by a system to identify generation data (e.g., image data) to be used for generating a non-fungible token. The method according to the embodiment may further include generating data indicating correspondence between the unique identifier and the data, and registering the data in the system. Here, the system may be a system for generating a non-fungible token. According to this method, the generation data used for generating a non-fungible token according to the unique identifier of the integrated circuit can be designated by the data recorded in the memory of the integrated circuit. The generation data is preferably possessed by the system. The system can receive not only the unique identifier but also the data recorded in the memory, and identify the generation data, based on the received data. The system may identify the generation data based on the received unique identifier by referring to the correspondence data indicating the correspondence between the unique identifier and the generation data.

(C2) A method according to the embodiment may include giving an object identifier to an object that includes an integrated circuit having a unique identifier. Preferably, the object identifier is visually recognizable. The phrase “visually recognizable” means that the presence of the object identifier can be visually recognized. The object identifier may not necessarily be read by a person, and may be read by a machine. An object identifier that can be visually recognized and read by a person is, for example, an identifier composed of marks, numerals, and/or characters. An object identifier that cannot be visually recognized and read by a person but can be read by a machine is, for example, a two-dimensional code. The method according to the embodiment may further include generating data indicating correspondence between the unique identifier and the object identifier, and registering the data in the system. The object identifier is used by the system to identify generation data to be used for generating a non-fungible token, or identify a non-fungible token to be operated. According to this method, even in a situation where the unique identifier cannot be read, the object identifier given to the system enables the system to generate or operate a non-fungible token. The situation where the unique identifier cannot be read is, for example, when a non-fungible token is generated or operated from an image obtained by capturing an object. More specifically, the above situation is, for example, when an image obtained by capturing an object is displayed on a digital market place (website) for resale of the object, a non-fungible token referring operation is performed on the object image displayed on a computer screen in order to confirm information on a non-fungible token corresponding to the object. Moreover, if the object identifier is present in addition to the unique identifier, a non-fungible token can be generated or operated without reading the unique identifier even in a situation where the unique identifier can be read. Therefore, the generation or operation method can be advantageously diversified.

(C3) An object according to the embodiment may be an object that includes an integrated circuit having a memory. The object may be used for generating a non-fungible token. This generation is the generation of the non-fungible token described in the above (C1) or (C2). The memory preferably has, stored therein, the unique identifier of the integrated circuit, and the data used by the system to identify the generation data to be used for generating the non-fungible token.

(C4) An object according to the embodiment may be an object that includes an integrated circuit having a unique identifier. An object identifier is preferably given to the object. As for the object identifier, refer to the above (C2).

### 2. Examples of Non-Fungible Token Production Method and Production System, Unique Identifier Registration Method and System, Combination Product Production Method, and the Like

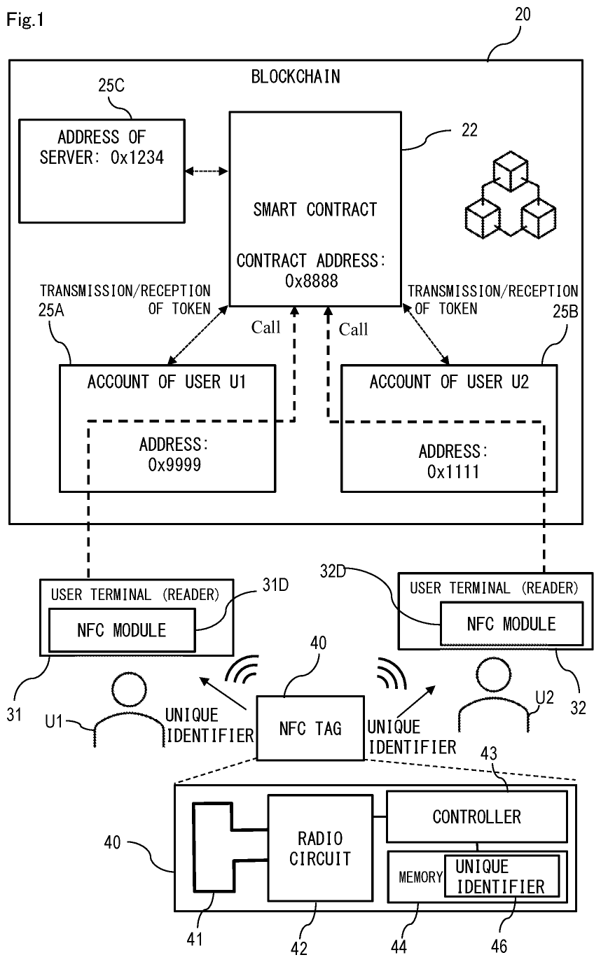

FIG. 1 shows a blockchain 20 and the like used in a system 10 according to an embodiment. The blockchain 20 is constituted by a P2P (Peer to Peer) computer network system in which a plurality of computers are connected to each other.

On the blockchain 20, a transaction is allowed between blockchain addresses. The transaction is recorded on a distributed ledger of the blockchain 20. The blockchain addresses are, for example, user accounts 25A, 25B on the blockchain 20. The blockchain addresses being the user accounts 25A, 25B are, for example, wallet addresses. The blockchain addresses being the user accounts 25A, 25B are, for example, externally owned accounts (EOA). For example, if a certain user U1 has the account 25A on the blockchain 20, this account has a predetermined blockchain address (wallet address). In FIG. 1, as an example, the blockchain address of a first user U1 is “0x9999”, and the blockchain address of a second user U2 is “0x1111”. FIG. 1 also shows a blockchain address 25C of a server 51 described later. The blockchain address 25C of the server 51 is “0x1234”.

On the blockchain 20, for example, transaction of tokens is allowed. Examples of tokens that can be transacted on the blockchain 20 include a fungible token (FT), and a non-fungible token (NFT). The fungible token is, for example, cryptocurrency (native token) such as Ether on Ethereum. The fungible token may be a unique fungible token that is issued on the blockchain by a specific issuer such as a company or an individual.

Unlike the fungible token (FT), the non-fungible token (NFT) does not have fungibility. In order to ensure non-fungibility, the NFT has a unique token identifier (Token ID) that makes the NFT distinguishable from other NFTs on the blockchain 20. This token identifier is also called an NFT identifier (NFT_ID). The token identifier is recorded on, for example, a blockchain address (contract address) for storage of the NFT. The contract address is also called a contract account.

On the blockchain 20, NFTs or fungible tokens possessed by the users U1, U2 are recorded in association with the user accounts 25A, 25B, respectively.

The blockchain 20 may include a smart contract 22. The system 10 may include the smart contract 22 implemented on the blockchain 20. The smart contract 22 is constituted by software (computer program) that is implemented to be executable on the blockchain. The smart contract 22 automatically executes a predetermined protocol such as an automatic transaction. The smart contract 22 of this embodiment may execute a process for transmitting an NFT, or a process for generating an NFT.

The aforementioned blockchain address sometimes indicates a contract address of the smart contract 22. The contract address is a blockchain address on which the smart contract 22 is stored. In FIG. 1, the contract address of the smart contract is, for example, “0x8888”.

On the blockchain 20, the smart contract 22 can also possess an NFT or an FT. On the blockchain 20, the NFT or the FT possessed by the smart contract 22 is recorded in association with the contract address of the smart contract 22.

The smart contract 22 is, for example, called through a calling operation from the outside of the smart contract 22, whereby a process is executed by the smart contract 22. The smart contract 22 is called from, for example, the user accounts 25A, 25B.

The process to be executed by the smart contract 22 is, for example, generation of an NFT or an operation on a token. The operation on a token is, for example, changing the owner of the token. The operation of changing the owner of the token is also called transmission of the token. That is, changing the owner of the token from a first blockchain address to a second blockchain address is equivalent to transmitting the token from the first blockchain address to the second blockchain address.

Transmission of the token may be, for example, transmitting the token from the contract address of the smart contract 22 to another blockchain address (e.g., a user account). As an example, only transmission and reception via the smart contract 22 are allowed for the NFT of this embodiment. The fact that only transmission and reception via the smart contract 22 are allowed is recorded on the blockchain 20. Therefore, the NFT of this embodiment cannot be directly transmitted and received between users, that is, cannot be directly transacted between users (it should be noted that the NFT may be directly transacted between users).

For example, the smart contract 22 can transmit an NFT to the blockchain address 25A of the user U1. When the smart contract 22 is called from the blockchain address 25A, the smart contract 22 can transmit the NFT to the blockchain address 25A of the caller. In addition, the user U1 can transmit an NFT from the blockchain address 25A of the user U1 to the smart contract 22. Likewise, the user U2 can also transmit and receive an NFT to and from the smart contract 22.

When the first user U1 desires to transfer an NFT to the second user U2, firstly, the first user U1 transmits the NFT from the blockchain address 25A of the first user U1 to the smart contract 22 to deposit the NFT in the smart contract 22. The second user U2 calls the smart contract 22 from the blockchain address 25B of the second user U2 to cause the smart contract 22 to transmit the NFT. The called smart contract 22 transmits the NFT possessed by the smart contract 22 to the blockchain address 25B of the caller. Thus, the NFT is transmitted from the first user U1 to the second user U2 via the smart contract 22.

In this embodiment, as an example, an object 40 described later may be used for such transmission and reception of an NFT via the smart contract 22. In other words, in this embodiment, in order to transmit or receive an NFT, a user who transmits or receives the NFT needs to have the object 40.

The operation on a token is not limited to changing the owner of the token (transmitting the token), and may be any process relating to the token. The operation on a token may be, for example, generation (issuance) of a non-fungible token.

In this embodiment, user terminals 31, 32 may operate as readers for a unique identifier 46 of the object 40. There is no particular limitation on the object 40 as long as the object 40 has the unique identifier 46 for identifying the object 40. As an example, the object 40 includes an integrated circuit (IC) having a unique identifier. The integrated circuit 40 may be, for example, an integrated circuit module (IC module) that includes a memory for storing therein data such as a unique identifier, and is configured to exchange the data such as the unique identifier with external devices. The integrated circuit module 40 may be called an integrated circuit tag (IC tag) or an integrated circuit card (IC card) depending on its form.

The integrated circuit module 40 may be of a contact type or a non-contact type. A contact integrated circuit module (contact IC module) has a contact point with an external communication device such as a reader/writer device, and is communicable with the external communication device via the contact point being in contact with the device. A non-contact integrated circuit module 40 (non-contact IC module 40) has an antenna, and is capable of contactless communication with an external radio communication device. The external communication device is, for example, a reader for reading data from the integrated circuit module, a writer for writing data in the integrated circuit module, or a reader/writer capable of reading and writing data.

The integrated circuit module 40 may be an active integrated circuit module having a built-in battery, or a passive integrated circuit module having no built-in battery.

The integrated circuit 40 being the object 40 includes a memory 44 for storing therein the data such as the unique identifier. The memory 44 is, for example, a read only memory (ROM). The unique identifier 46 of the integrated circuit 40 is preferably stored in the read only memory. The memory 44 preferably includes a non-volatile memory. The non-volatile memory 44 may constitute a read only memory. The unique identifier 46 of the integrated circuit 40 is preferably stored in the non-volatile memory 44. The non-volatile memory 44 is, for example, a mask ROM, a PROM, an EPROM, an EEPROM, an FeRAM, or a flash memory.

The unique identifier 46 of the integrated circuit 40 is preferably a non-rewritable unique identifier that is given to the integrated circuit 40 by the manufacturer of the integrated circuit 40. The unique identifier (UID) 46 of the integrated circuit 40 is used for identifying the integrated circuit 40 by distinguishing the integrated circuit 40 from other integrated circuits. The unique identifier (UID) 46 given to the integrated circuit 40 by the manufacturer is written in the memory 44 when the integrated circuit 40 is manufactured, for example. The unique identifier 46 is written in the memory 44 by the time the manufacturer ships the integrated circuit 40, at the latest. Therefore, a purchaser of the integrated circuit 40 shipped by the manufacturer can obtain the integrated circuit 40 in which the unique identifier 46 has already been written. As a result, the purchaser or user of the integrated circuit 40 need not write the unique identifier 46 in the integrated circuit 40. In this embodiment, the unique identifier 46 written in the integrated circuit 40 may be used for a process relating to a token to be transacted on the blockchain. The memory 44 of the integrated circuit 40 may have an area in which the purchaser or user of the integrated circuit 40 can write data. For example, data, which is used by the system to identify generation data to be used for generating a non-fungible token, is written in the memory area in which the user or the like can write data. The data used by the system to identify the generation data is, for example, an NFT Name (to be written in the memory) described later.

The non-contact IC module having a unique identifier is also called a radio frequency identification (RFID) device. The radio frequency identification (RFID) device transmits the data such as the unique identifier to an external radio communication device through radio communication. The data to be transmitted is data stored in the memory 44, and may include the data to be used by the system to identify the generation data. The external radio communication device can read the unique identifier by receiving the data such as the unique identifier transmitted from the radio frequency identification (RFID) device. The radio frequency identification (RFID) device having a form of a tag may be called a radio frequency identification (RFID) tag.

The radio frequency identification (RFID) device may be a near field communication device. Near field communication is preferably communication according to the NFC standard. NFC is, for example, radio communication using a frequency band of 13.56 MHz. The communication distance of near field communication is preferably 10 cm or less. The near field communication (NFC) device having a form of a tag may be called a near field communication (NFC) tag.

The object 40 is not limited to an object that includes an integrated circuit having a unique identifier, and may be any other object having a unique identifier. The unique identifier may be, for example, a serial number assigned to a product as the object 40. A serial number is assigned to each product to identify the product. The serial number is also called a production number. The product may be software. The unique identifier may be, for example, a ticket number assigned to a ticket as the object 40. The ticket is, for example, a ticket for boarding a vehicle, or a ticket for participation or admission to an event such as a movie or a concert.

The unique identifier may be, for example, a certificate number assigned to a certificate as the object 40. The certificate is, for example, a driver's license, a student ID card, an employee ID card, or a health insurance card. The unique identifier may be, for example, a credit card number assigned to a credit card as the object 40, or a cash card number assigned to a cash card as the object 40.

The unique identifier may be represented by a machine-readable code such as a barcode or a two-dimensional code, or may be represented by human-readable numbers, characters, and/or symbols. When the unique identifier is a machine-readable code, the reader only needs to have a function as a code reader. The code reader is configured to have a code scanner or a camera, for example. When the unique identifier is represented by numbers, characters, and/or symbols, the reader only needs to include a camera and a character recognizer. A smartphone with a camera is preferably used as the reader.

The unique identifier may be a media access control address (MAC address) given to a network device. A MAC address is an address uniquely assigned to a network device to identify the network device. A device capable of acquiring the MAC address through communication with the network device is preferably used as the reader for the unique identifier.

The following description is given for, as an example, a case where the object 40 is an NFC tag, but does not intend to limit the object 40 to the NFC tag. The object 40 may be called an article.

The terminals 31, 32 that function as readers for the NFC tag 40 are provided with near field communication modules 31D, 32D (NFC modules 31D, 32D), respectively. Each of the terminals 31, 32 can perform near field communication with the NFC tag 40.

As shown in FIG. 1, the NFC tag 40 includes an antenna 41, a radio circuit 42 connected to the antenna 41, a controller 43 connected to the radio circuit 42, and a memory 44 connected to the controller 43. The memory 44 has, written therein, the unique identifier 46 of the NFC tag 40. The memory 44 may have other data written therein. The memory 44 is a non-volatile memory such as an EEPROM.

In this embodiment, the data such as the unique identifier 46 is transmitted from the NFC tag 40 to the terminal 31, 32, 33 serving as the reader. For example, when the user U1, U2, U3 holds the terminal 31, 32, 33 over the NFC tag 40, the data such as the unique identifier 46 is transmitted to the terminal 31, 32, 33 through near field communication. The unique identifier 46 read by the terminal 31, 32, 33 serving as the reader is transmitted to the system 10. The system 10 acquires the data such as the unique identifier 46 from the terminal 31, 32, 33 serving as the reader.

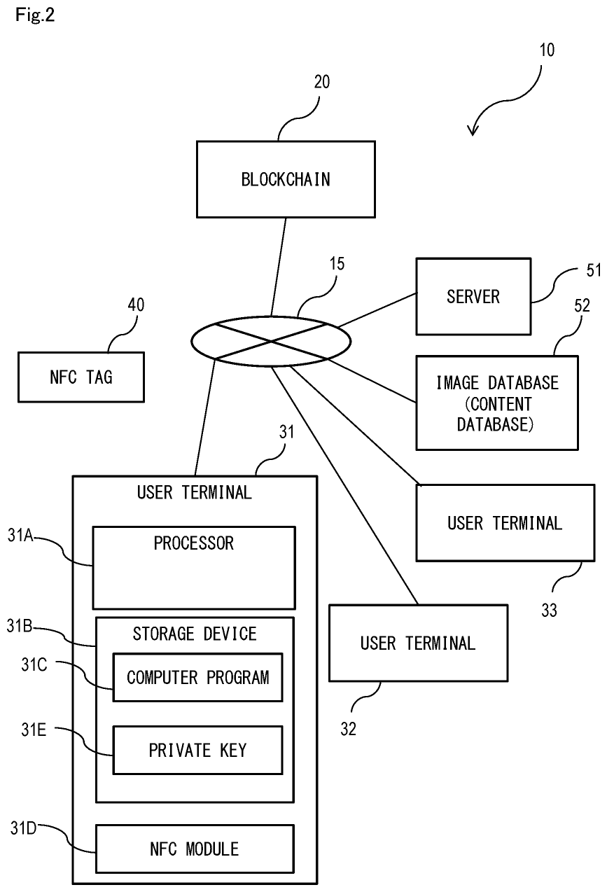

FIG. 2 shows an example of elements constituting the system 10 according to the embodiment. In this embodiment, the system 10 may operate as an NFT production system. The production system 10 produces an NFT by using a unique identifier possessed by an object 40. In addition, the system 10 may operate as a management system for the produced NFT and the like. The management system 10 manages the produced NFT by using the unique identifier possessed by the object 40. The management system 10 may manage other tokens by using the unique identifier possessed by the object 40. The management system 10 may be called an NFT operation system 10. The operation system 10 may operate as an operation system for NFT production or other NFT operations.

The system 10 shown in FIG. 2 may include a server 51 connected to a network 15. The server 51 may be composed of a plurality of computers. The server 51 may be managed by an administrator of the system 10. The administrator may be an administrator (producer) of the smart contract 22. The smart contract 22 may have some or all of the functions of the server 51.

The user terminals 31, 32, 33 may access the server 51 via the network 15. As an example, the server 51 may receive the unique identifier 46 transmitted from the terminal 31, 32, 33 serving as the reader. The terminals 31, 32, 33 may access the blockchain 20 via the network 15. The smart contract 22 on the blockchain 20 may receive the unique identifier 46 transmitted from the terminal 31, 32 serving as the reader. The terminals 31, 32, 33 may access the blockchain 20 via the server 51.

The terminal 31 is, for example, a mobile device such as a smartphone or a tablet. Although the configuration of the terminal 31 will be described below, the terminals 32, 33 may have the same configuration as the terminal 31.

The terminal 31 is connectable to the network 15 such as the Internet. The user terminal 31 may be constituted by a computer including a processor 31A and a storage device 31B. The storage device 31B is connected to the processor 31A. The storage device 31B includes, for example, a primary storage device and a secondary storage device. The primary storage device is, for example, a RAM. The secondary storage device is, for example, a hard disk drive (HDD) or a solid state drive (SSD). The storage device 31B includes a computer program 31C to be executed by the processor 31A. The processor 31A reads out the computer program 31C stored in the storage device 31B, and executes the computer program 31C. The computer program 31C has a program code indicating a command to be executed by the computer that functions as the terminal 31.

The computer program 31C may provide a function for receiving data, from the NFC tag 40, via near field communication due to the NFC module 31D. The computer program 31C may provide a function of storing, in the storage device 31B of the terminal 31, a private key 31E for an account on the blockchain 20. The private key 31E is associated with the account 25A of the user U1. The private key 31E is used for, for example, digitally signing a transaction record on the blockchain 20. The private key 31E corresponds to an account on the blockchain 20. Therefore, in order to call the smart contract 22 from the account and cause the smart contract 22 to transmit a token to the account, the private key 31E corresponding to the account is required. The private key may be stored in, for example, an external device such as the server 51 accessible by the terminal 31.

The computer program 31C may be, for example, a wallet application program for causing the terminal 31 to display a token stored in a user account (wallet address) on the blockchain 20. Such a program may provide functions for user operations regarding storage of a token, transmission of a token, and reception of a token. The application program 31C may provide a function for calling the smart contract 22. That is, the processor 31A may execute a calling process for the smart contract 22 by executing the computer program 31C.

The computer program 31C in the terminal 31 of the first user U1 may be, for example, a program that causes the terminal 31 to execute a process for producing an NFT and to be executed in the terminal 31.

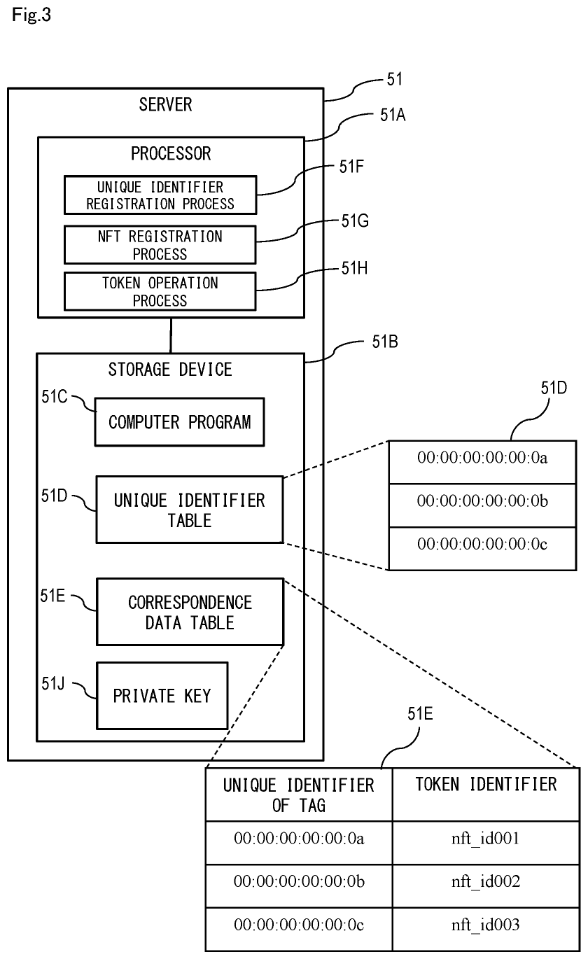

As shown in FIG. 3, the server 51 may be constituted by a computer including a processor 51A and a storage device 51B. The storage device 51B is connected to the processor 51A. The storage device 51B includes, for example, a primary storage device and a secondary storage device. The primary storage device is, for example, a RAM. The secondary storage device is, for example, a hard disk drive (HDD) or a solid state drive (SSD). The storage device 51B includes a computer program 51C to be executed by the processor 51A. The processor 51A reads out the computer program 51C stored in the storage device 51B, and executes the computer program 51C. The computer program 51C has a program code indicating a command that causes the computer to execute various processes 51F, 51G, 51H.

The processes 51F, 51G, 51H that the server 51 executes may include a unique identifier registration process 51F. The unique identifier registration process 51F is a process of registering the unique identifier 46 possessed by the NFC tag 40 (object 40), on a unique identifier table 51D. The unique identifier 46 being registered in the system 10 allows the NFC tag 40 (object 40) having the unique identifier to be used for at least one of the processes including NFT production and NFT operations.

A plurality of unique identifiers may be registered on the unique identifier table 51D. For example, the unique identifier 46 of the NFC tag 40 to be used for NFT generation can be registered on the unique identifier table 51D. In addition, the unique identifier 46 of the NFC tag 40 to be associated with a generated NFT may be registered on the unique identifier table 51D. In FIG. 3, as an example, three different unique identifiers, “00:00:00:00:00:0a”, “00:00:00:00:00:0b”, and “00:00:00:00:00:0c”, are registered on the unique identifier table 51D.

As an example, using the unique identifier table 51D allows NFC tags 40 (objects 40) usable for NFT generation to be limited to tags whose unique identifiers are registered in advance on the unique identifier table 51D. In this case, even when an NFC tag 40 or another object has a unique identifier, if this unique identifier is not registered on the unique identifier table 51D, the NFC tag 40 or the other object cannot be used for NFT generation.

The production system 10 of this embodiment is configured not to generate an NFT when acquiring an unregistered unique identifier, and to generate an NFT when acquiring the same unique identifier as a unique identifier registered in the production system 10.

That is, the production method of this embodiment may include: receiving, by a non-fungible token production system, a unique identifier transmitted from a reader that has read the unique identifier of an object; and generating a non-fungible token by the production system when the received unique identifier is registered in the production system. According to this production method, an object whose unique identifier is registered in the production system 10 can be used for NFT generation, whereas an object whose unique identifier is not registered in the production system 10 cannot be used for NFT generation.

As described above, in this embodiment, NFC tags 40 (objects 40) that can be used for NFT operations, such as NFT generation, can be limited to tags whose unique identifiers are registered. In this case, the NFC tag 40 (object 40) whose unique identifier is registered has an added value that the NFC tag 40 can be used for NFT operations such as NFT generation, in contrast to the NFC tag 40 (object 40) whose unique identifier is not registered. That is, an increase in the added value of an object such as the NFC tag 40 can be achieved.

The NFC tag 40 whose unique identifier is registered can be utilized for new uses, i.e., NFT operations such as NFT generation. Since an NFT has uniqueness, data for identifying an NFT varies from NFT to NFT. Therefore, if it is attempted to prepare a large number of objects 40 to which data for identifying NFTs are given, much labor and time are required for giving different data to the large number of objects 40, resulting in a heavy workload. Meanwhile, if an object having a unique identifier in advance, such as an NFC tag 40 with a unique identifier, is used for NFT operations and the like, the labor and time for giving the data to the objects 40 can be eliminated.

As another example, the system 10 can receive registration of an NFC tag 40 whose unique identifier is not yet registered. This NFC tag 40 becomes usable for NFT operations such as NFT generation, through registration of the unique identifier. The system 10 can provide a service of receiving registration of a unique identifier, in order to enable NFT operations using the NFC tag 40.

As an example, the production system 10 of this embodiment is configured such that the system 10, which generates an NFT, registers a unique identifier of an object 40 into the system 10 upon acquiring the unique identifier. After the registration, the production system 10 can generate an NFT associated with the registered unique identifier. The system 10 may associate the unique identifier acquired by the system 10 with an already-generated NFT.

The processes 51F, 51G, 51H that the server 51 executes may include an NFT registration process 51G. The NFT registration process 51G is, as an example, a process relating to NFT generation. The NFT registration process 51G may be generating an NFT with necessary data being written on the blockchain 20 by the server 51, or may be calling the smart contract 22 to cause the smart contract 22 to generate an NFT. One NFT registration process may generate one NFT, or a plurality of NFTs.

Furthermore, the NFT registration process 51G may include, as an example, registering, on a correspondence data table 51E, correspondence data indicating correspondence between a unique identifier of an NFC tag 40 and a token identifier of an NFT. The correspondence data being registered allows the NFT to be associated with the unique identifier. That is, the object 40 having the unique identifier 46 and the NFT can be associated with each other. The NFT associated with the unique identifier may be an NFT generated in the NFT registration process 51G, or may be an NFT that has already been generated before execution of the NFT registration process 51G.

The correspondence relationship between the NFC tag 40 and the NFT being registered on the correspondence data table 51E allows the NFC tag 40 having the unique identifier to be used for operations on the NFT. That is, the unique identifier of the NFC tag 40 can be used as the identifier of the NFT to be operated.

In FIG. 3, as an example, a unique identifier “00:00:00:00:00:0a” is associated with a token identifier “nft_id001”, a unique identifier “00:00:00:00:00:0b” is associated with a token identifier “nft_id002”, and a unique identifier “00:00:00:00:00:0c” is associated with a token identifier “nft_id003”.

With reference to the correspondence data table 51E, a token identifier of an NFT can be obtained from a unique identifier of an NFC tag 40 (object 40). In addition, with reference to the correspondence data table 51E, a unique identifier of an NFC tag 40 (object 40) can be obtained from a token identifier of an NFT. A unique identifier of one NFC tag 40 (object 40) may be associated with a plurality of token identifiers. One token identifier may be associated with unique identifiers of a plurality of NFC tags (objects) 40.

The correspondence data indicating the correspondence between the unique identifiers of the NFC tag 40 and the token identifier of the NFT may be recorded in a computer outside the blockchain 20, other than the server 51, or may be recorded on the blockchain 20. The correspondence data may be included in data constituting the NFT recorded on the blockchain 20.

The processes 51F, 51G, 51H that the server 51 executes may include a token operation process 51H. Here, as an example, the token operation process 51H is a process relating to a token, other than NFT generation. For example, the process relating to a token includes at least one of: referring to an NFT recorded on the blockchain; transmission of an NFT or an FT; reception of an NFT or an FT; editing of data, outside the blockchain, associated with an NFT; calling of a smart contract for an operation on a token (e.g., transmission or reception of an NFT or an FT); and payment to a person having a right relating to an NFT. In the token operation process 51H, a token identifier of an operation target can be obtained from a unique identifier of an NFC tag 40 by referring to the correspondence data table 51E. The token identifier may indicate the quantity of FTs to be operated. If the token identifier of the operation target is known, it is not necessary to refer to the correspondence data table 51E during the token operation process 51H.

The system 10 of this embodiment may include one or a plurality of smart contracts 22 implemented on the blockchain 20. The server 51 may have some or all of the functions of the smart contract 22.

The server 51 may have, stored therein, a private key 51J for the blockchain address 25C of the server 51. The blockchain address 25C of the server 51 may be a wallet address, like a user account. In this embodiment, for example, since the server 51 generates an NFT 400 on behalf of the user U1 who desires to generate the NFT 400, the blockchain address 25C of the server 51 is used instead of the blockchain address 25A of the user U1. The private key 51J corresponds to the blockchain address 25C of the server 51. The blockchain address 25C of the server 51 is, for example, a blockchain address of the administrator of the system 10. The private key 51J is preferably encrypted and stored in the server 51. For NFT generation, the smart contract 22 may be called from the blockchain address 25C. The called smart contract generates an NFT.

In this embodiment, an NFT is generated by, for example, writing NFT data in a contract address (e.g., “0x8888” in FIG. 1) on the blockchain 20. The blockchain address that is allowed to write NFT data into the contract address in which the NFT data should be written may be limited to, for example, the blockchain address 25C of the server 51. That is, on the blockchain 20, the blockchain address having a right to generate an NFT is preferably limited. In other words, the smart contract 22 is preferably set such that the blockchain addresses 25A, 25B of the users and the like cannot write the NFT data into the contract address of the smart contract 22. The contract address is the blockchain address in which the smart contract 22 is stored.

Since the server 51 of this embodiment has the private key 51J corresponding to the blockchain address 25C that can be used for generation of the NFT 400, the server 51 can generate an NFT according to need, for example, when receiving a unique identifier. The server 51 can generate an NFT by, for example, writing the NFT data in the contract address of the smart contract 22.

The private key 51J may be recorded in association with one or a plurality of unique identifiers registered in the server 51. For example, a first private key may be recorded in association with one or a plurality of first unique identifiers, and a second private key may be recorded in association with one or a plurality of second unique identifiers.

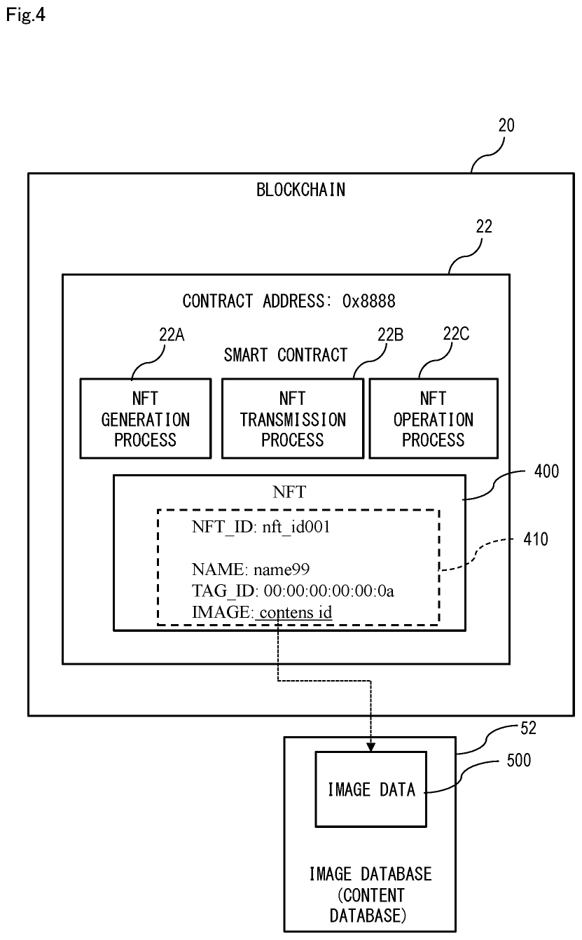

As shown in FIG. 4, the smart contract 22 may execute a generation process 22A for an NFT 400. The generation process 22A is executed, for example, when the smart contract 22 is called from the server 51 for generation of the NFT 400. A process for calling the smart contract 22 may be executed by the server 51, by the terminal 31, or by the terminal 31 via the server 51. For example, the server 51 is configured to call the smart contract 22 upon acquiring a unique identifier from the terminal 31 as a reader.

In the generation process 22A, as an example, the smart contract 22 acquires the unique identifier read by the terminal 31 as a reader, and generates an NFT 40 corresponding to the acquired unique identifier. Acquisition of the unique identifier by the smart contract 22 may be performed via the server 51 or without the server 51 intervening.

The NFT 400 is generated when NFT data 410 constituting the NFT 400 is recorded on the blockchain 20. The NFT data 410 is recorded in the contract address (“0x8888” in FIG. 1 or FIG. 4) of the smart contract 22. Generation of the NFT 400 may be performed not by the smart contract 22 but by the server 51. That is, the NFT may be generated when the server 51 writes the NFT data 410 in the contract address of the smart contract 22. When generation of the NFT 400 is performed through a process by the server 51, the generation process 22A may be omitted.

The NFT data 410 includes a token identifier of the NFT 400. The token identifier (NFT_ID) of the NFT 400 shown in FIG. 4 is “nft_id001”. The token identifier of the NFT 400 to be generated may be determined by the server 51 or the smart contract 22 when the NFT 400 is generated.

The NFT data 410 may include a unique identifier of an NFC tag 40 (object 40) associated with the NFT 400. The unique identifier (TAG_ID) shown in FIG. 4 is “00:00:00:00:00:0a”.

The pair of the token identifier (NFT_ID) and the unique identifier (TAG_ID) included in the NFT data 410 may constitute correspondence data indicating the correspondence between the token identifier and the unique identifier. For example, the server 51 may acquire the token identifier from the unique identifier with reference to the correspondence data recorded on the blockchain 20.

The NFT data 410 may include other data besides the data described above. The other data is, for example, data relating to the NFC tag 40 and other than the unique identifier. The other data is, for example, data recorded in the memory 44 of the NFC tag 40 and other than the unique identifier. Since the data recorded on the blockchain 20 cannot be rewritten/altered, certification of accuracy of the data relating to the NFC tag 40 is facilitated by non-fungible tokenizing the data relating to the NFC tag 40 (object 40). As shown in FIG. 4, the combination of the token identifier and the unique identifier is non-rewritably recorded on the blockchain 20, whereby the correspondence between the object 40 having the unique identifier and the NFT 400 having the token identifier is certified by the blockchain 20.

The other data constituting the NFT data 410 may be data relating to an attachment object to which the NFC tag 40 is attached. Since the data recorded on the blockchain 20 cannot be rewritten/altered, certification of accuracy of data relating to the attachment object to which the NFC tag 40 (object 40) is attached is facilitated by non-fungible tokenizing the data relating to the attachment object. As shown in FIG. 4, the combination of the token identifier, the unique identifier, and the data relating to the attachment object is non-rewritably recorded on the blockchain 20, whereby the correspondence between the attachment object to which the object 40 having the unique identifier is attached, and the NFT 400 having the token identifier is certified by the blockchain 20.

Examples of the attachment object to which the NFC tag 40 (object 40) is attached include various industrial products, other products, plants, animals, and other objects. Since the NFC tag 40 has the unique identifier, the attachment object need not have a unique identifier. The object 40 having the unique identifier is attached to the attachment object, whereby the unique identifier is given to the attachment object. As a result, the attachment object, which may not have a unique identifier, is associated with the NFT 400 via the NFC tag 40. In other words, using the unique NFC tag 40 allows the unique NFT 400 to be associated with the attachment object that may not be unique.

The NFC tag 40 (object 40) may be attached to the outside of the attachment object, or the inside of the attachment object. Attachment to the inside of the attachment object may be, for example, embedding the NFC tag 40 (object 40) in the attachment object.

The data relating to the attachment object is, for example, at least one of: the name of the attachment object; the attribute/feature of the attachment object; image data of the attachment object; and other data relating to the attachment object. In FIG. 4, the data relating to the attachment object includes the name of the attachment object (NAME: name99), and image data 500 of the attachment object.

A part or the entirety of the data 410 constituting the NFT 400 may be stored in a computer outside the blockchain 20. The image data 500, which may be unsuitable to be recorded on the blockchain 20, may be stored in a database 52 as the computer outside the blockchain 20. Data other than the image data 500 may be stored in the database 52. The database 52 may constitute a part of the system 10.

The NFT data 410 recorded on the blockchain 20 may include a link indicating the data stored in the computer outside the blockchain 20. The link is constituted by, for example, a uniform resource identifier (URI).

The database 52 may be constituted by, as an example, an IPFS (InterPlanetary File System). The IPFS is an example of a P2P (Peer to Peer) distributed file system. In the IPFS, stored data (content) is designated by a URI using a hash value obtained from the data. This URI is also called a content identifier. A link indicating the content stored in the computer outside the blockchain 20 may be a URI that designates the content in the IPFS. In FIG. 4, the URI of the image data 500 stored in the database 52 is represented as “contents_id”.

As shown in FIG. 4, the smart contract 22 may execute a transmission process 22B for an NFT 400. The transmission process 22B is executed, for example, when the smart contract 22 is called for transmission of the NFT 400. The transmission process 22B for the NFT 400 is executed, for example, when the smart contract 22 is called from an account to receive the NFT 400. Upon being called, the smart contract 22 transmits the NFT 400 to the account of the caller.

Calling of the smart contract 22 for transmission of the NFT 400 may be executed before generation of the NFT 400. In this case, the smart contract 22 may wait until the NFT 400 is generated, and after the NFT 400 is generated, may transmit the NFT 400. When the smart contract 22 is called, the NFT 400 to be transmitted may be designated. Designation of the NFT 400 to be transmitted may be performed based on the token identifier, or the unique identifier corresponding to the token identifier.

The smart contract 22 may execute an operation process 22C for an NFT 400, other than NFT transmission. Not all the processes 22A, 22B, 22C have to be executed by one smart contract 22. A plurality of smart contracts corresponding to the respective processes may be used.

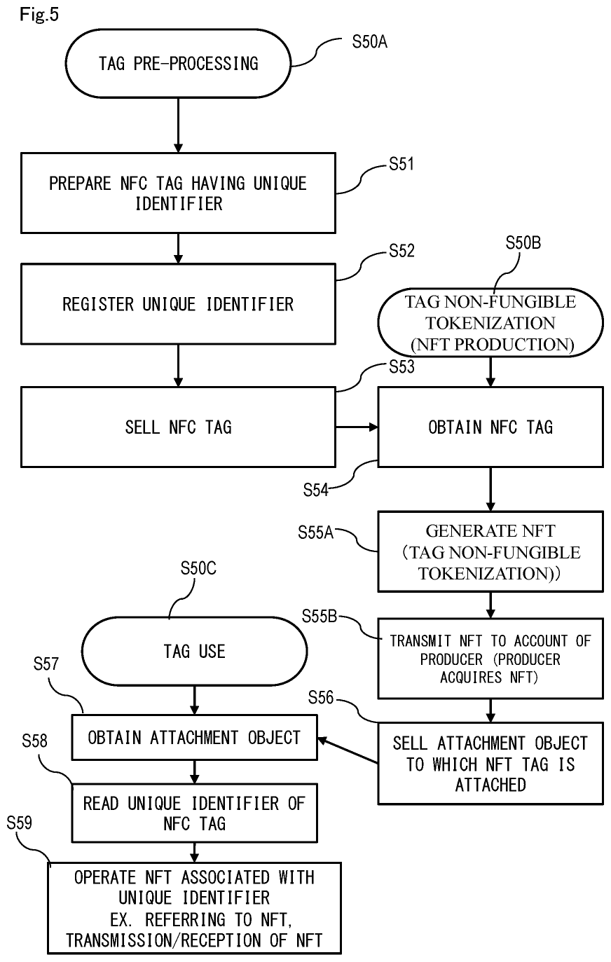

FIG. 5 shows an outline of an example of a procedure for utilizing an NFC tag 40 according to the embodiment. The procedure shown in FIG. 5 includes tag pre-processing S50A, tag non-fungible tokenization S50B, and tag use S50C.

The tag pre-processing S50A shown in FIG. 5 includes registration of a unique identifier, and, for example, a seller of the NFC tag 40 participates in the tag pre-processing S50A. Here, the seller of the NFC tag 40 is a company or an individual that sells the NFC tag 40 whose unique identifier is registered.

Firstly, in step S51, the tag seller prepares the NFC tag 40. In order to prepare the NFC tag 40, for example, the tag seller may purchase the NFC tag 40 from the manufacturer of the NFC tag 40 or another seller. Since the NFC tag 40 purchased by the tag seller already has the unique identifier written therein, the tag seller need not write the unique identifier into the NFC tag 40.

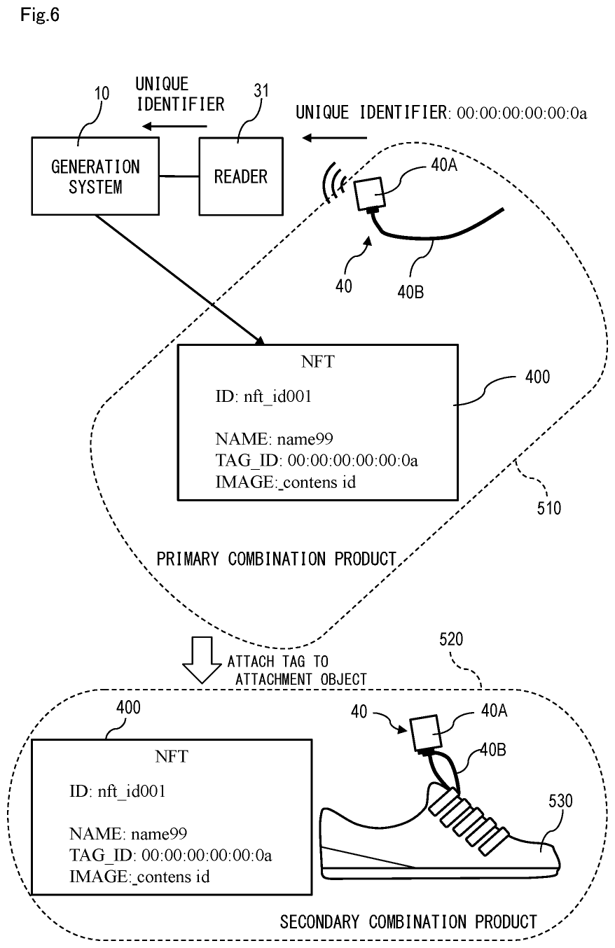

Here, as an example, the NFC tag 40 is a cable tie type NFC tag 40 as shown in FIG. 6. The cable tie type NFC tag 40 includes a tag body 40A, and a cable tie 40B integrated with the tag body 40A. The tag body 40A includes the antenna 41, the radio circuit 42 connected to the antenna 41, the controller 43 connected to the radio circuit 42, and the memory 44 connected to the controller 43, as shown in FIG. 1. The cable tie 40B is used for attachment to an attachment object.

The cable tie 40B is an example of an attachment tool for attaching the NFC tag (object 40) to an attachment object. The attachment tool is not limited to the cable tie 40B, and may be a strap, etc., if the tool has a structure or a function suitable for being attached to the attachment object. The attachment tool may have, for example, an adhesive agent for attaching the same to the attachment object.

Referring back to FIG. 5, in step S52, the tag seller registers the unique identifier of the NFC tag 40 in the system 10. In order to register the unique identifier, for example, the tag seller registers the unique identifier of the purchased NFC tag 40 onto the unique identifier table 51D of the server 51. The unique identifier of the purchased NFC tag 40 may be registered on the blockchain 20. The tag seller may acquire the unique identifier of the purchased NFC tag 40 by reading the same from the NFC tag 40, or by receiving data indicating the unique identifier provided from the manufacturer that sold the NFC tag 40, or from another seller.

In step S52, the server 51 executes the unique identifier registration process 51F. In the unique identifier registration process 51F, the server 51 acquires one or a plurality of unique identifiers from the outside via the network 15, and registers the acquired unique identifiers on the unique identifier table 51D. The unique identifier is preferably encrypted and registered in order to conceal the same or prevent alteration.

In step S53, the tag seller sells the NFC tag 40 whose unique identifier is registered. The tag seller may sell the NFC tag 40 after writing necessary data into the memory 44 of the NFC tag 40. The data written in the memory 44 is, for example, data necessary for accessing the system 10. The data necessary for accessing the system 10 is, for example, a URL for accessing the server 51. The data necessary for accessing the system 10 may be authentication information used for access, such as an ID and/or a password for access. The data written in the memory 44 may be, for example, data that is used by the system 10 having received the unique identifier, to identify generation data to be used for NFT generation.

The NFC tag 40 being sold in step S53 may be subjected to any processing. The processing is, for example, covering the NFC tag 40 with casing. The processing may be performed at any time point in a period from S51 to S53. The casing may be given a trademark, or marks/characters indicating that the NFC tag 40 can be used for generation of an NFT 400 or other NFT operations. The casing may be given the data necessary for accessing the system 10 described above. For example, the casing may be given a two-dimensional code indicating the URL for accessing the server 51. Such a two-dimensional code is read by the terminal 31 with a camera, and allows the terminal 31 to easily access the server 51. Thus, the NFC tag 40 according to this embodiment may include the NFC tag body having the unique identifier, and the two-dimensional code indicating the URL for accessing the system 10. The system 10 may be a system for NFT generation or NFT management.

The tag non-fungible tokenization S50B shown in FIG. 5 includes producing an NFT by using the NFC tag 40, and an NFT producer participates in the tag non-fungible tokenization S50B. The NFT producer is a company or an individual that generates an NFT by using the NFC tag 40. The NFT producer may be the same as the seller described above.

For example, the NFT producer acquires the NFC tag 40 whose unique identifier is registered, by purchasing the NFC tag 40 sold in step S53 (step S54). The NFT producer generates an NFT by using the acquired NFC tag 40 (step S55A). The tag producer may acquire the NFC tag 40 at no cost, or may generate an NFT by using the NFC tag 40 possessed by the tag seller.

In step S55A, the NFT producer reads the unique identifier of the NFC tag 40 with a reader 31 as shown in FIG. 6. The read unique identifier is transmitted from the reader 31 to the production system 10 via the network 15. The read unique identifier may be received by, for example, the server 51. The reader 31 may transmit the blockchain address 25A of the first user U1 to the system 10 to cause the server 51 to identify the blockchain address 25A of the first user U1 as the NFT producer. The blockchain address 25A of the first user U1 may be transmitted to the system 10 before or after transmission of the unique identifier to the system 10. The blockchain address 25A of the first user U1 may be received by, for example, the server 51.

Upon acquiring the unique identifier from the reader 31, the production system 10 produces an NFT 400. Using the received unique identifier, the production system 10 can produce the NFT 400 associated with the received unique identifier. In step S55A, the production system 10 may register correspondence data between the unique identifier and the token identifier of the generated NFT 400.

The production system 10 allows the first user U1 to acquire the generated NFT 400. For example, the production system 10 transmits the NFT 400 to the blockchain address 25A of the first user U1 as the NFT producer (step S55B). Thus, the first user U1 as the NFT producer has acquired the NFT 400 by using the NFT 40. The NFT 400 is displayed on, for example, the display of the terminal 31.

In the case where the NFT 400 associated with the received unique identifier is produced, a combination product of the NFC tag 40, and the NFT 400 associated with the unique identifier of the NFC tag 40 can be obtained. In FIG. 6, this combination product is shown as “primary combination product 510”. The primary combination product 510 has an added value that the NFT 400 is included, compared to the product of the NFC tag 40 alone

The evidence to back up the correspondence between the NFC tag 40 and the NFT 400 may be secured by, for example, the fact that the correspondence data indicating the correspondence between the unique identifier of the NFC tag 40 and the token identifier of the NFT 400 is recorded in the system 10.

FIG. 6 also shows a secondary combination product 520 that is obtained by attaching the NFC tag 40 to sneakers 530 as an example of the attachment object by using the cable tie 40B or the like. The NFT producer can produce the secondary combination product 520 by attaching the NFC tag 40 to the attachment object 530. The secondary combination product 520 has an added value that the NFT 400 is included, compared to the product of the attachment object 530 alone.

The evidence to back up the correspondence between the attachment object 530 and the NFT 400 may be secured by, for example, the fact that the correspondence data indicating the correspondence between the unique identifier of the NFC tag 40 and the token identifier of the NFT 400 is recorded in the system 10.

Attachment of the NFC tag 40 to the attachment object 530 may be performed after production of the NFT 400, or before production of the NFT 400. The NFT producer can sell the attachment object 530 to which the NFC tag 40 is attached (step S56). The NFT producer may sell the NFC tag 40 associated with the NFT 400 without attaching the same to the attachment object 530. In this case, attachment to the attachment object 530 may be performed by the purchaser of the sold NFC tag 40.

If the NFT 400 has data relating to the attachment object 530, the NFT 400 can indicate the data relating to the attachment object 530. If the NFT 400 is associated with the unique identifier of the NFC tag 40, the attachment object 530 to which the NFC tag 40 is attached is also associated with the NFT 400. In this case, the NFT 400 is used for, for example, certifying that the attachment object 530 to which the NFC tag 40 is attached is a genuine product.

The NFT producer can sell the attachment object 530 to which the NFC tag 40 is attached, to others (step S56). The NFC tag 40 may be used by, for example, a purchaser of the attachment object 530.

The tag use S50C shown in FIG. 5 includes operating the NFT 400 by using the NFC tag 40, and is performed by a tag user. The tag user is a company or an individual who performs the act of reading the tag, and may be an owner or a non-owner of the NFC tag 40. The tag user may be, for example, the second user U2 shown in FIG. 1. The NFT user may be identical to the NFT producer.

In step S57, the tag user U2 reads the unique identifier 46 of the NFC tag by using, as a reader, the terminal 32 of the tag user U2. The read unique identifier is transmitted from the reader 31 to the management system 10 via the network 15. The read unique identifier may be transmitted to, for example, the server 51. Upon acquiring the unique identifier from the reader 32, the management system 10 executes a process relating to the NFT 400 associated with the unique identifier. This process operates the NFT 400 associated with the unique identifier. The management system 10 can specify an NFT to be operated, based on the unique identifier, by using the correspondence data between the unique identifier and the token identifier of the NFT. The operation on the NFT 400 may be, for example, to refer to the data constituting the NFT 400 and recorded on the blockchain 20, or to transmit/receive the NFT 400. The operation on the NFT 400 may be to acquire the NFT 400.

A person who performs the tag non-fungible tokenization shown in FIG. 5 may be, for example, a pet owner who has purchased the NFC tag 40 to be attached to his/her pet such as a dog or a cat. The pet owner reads the unique identifier of the NFC tag 40 with the terminal 32, and transmits the unique identifier to the system 10. Data such as the name of the pet, an image of the pet, and contact information of the pet owner are transmitted as the NFT data from the terminal 32 to the system 10. The system 10 generates an NFT by using the NFT data such as the name of the pet. Thus, the pet to which the NFC tag 40 is attached is associated with the NFT. The system 10 allows the pet owner to acquire the NFT. For example, the system 10 transmits the NFT to a blockchain account of the pet owner.

For example, if the pet is lost, a person who has found the pet reads the unique identifier of the NFC tag 40 attached to the pet, and refers to the NFT associated with the unique identifier, thereby acquiring information such as the contact information of the pet owner.

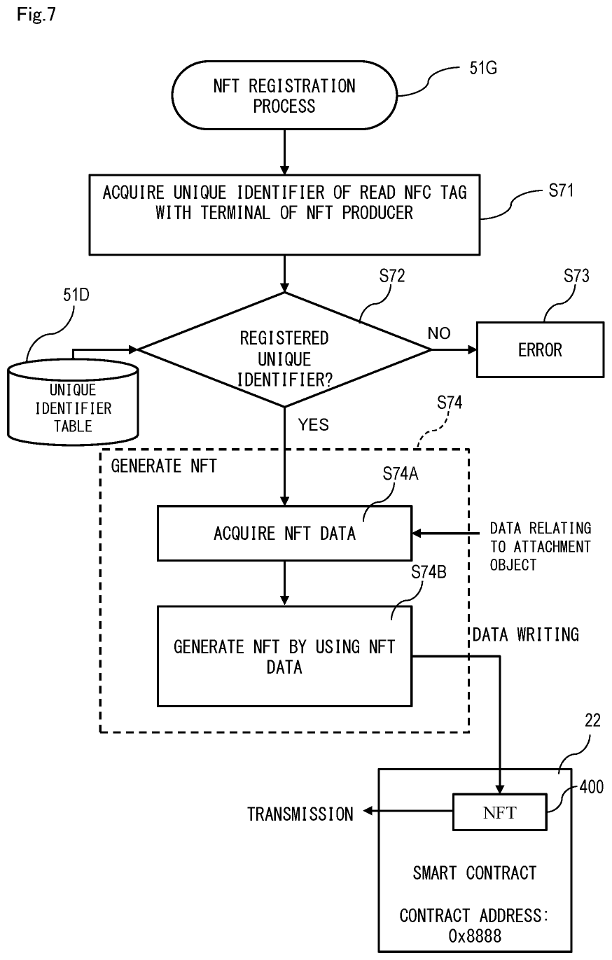

FIG. 7 shows an example of the NFT registration process 51G that the server 51 executes in step S55A in FIG. 5. The NFT registration process 51G may be called an NFT production process 51G. In step S71, the server 51 acquires the unique identifier of the NFC tag 40 from the terminal 31 (reader) of the first user U1 as the NFT producer.

In step S71, the server 51 determines whether or not the received unique identifier is a unique identifier registered in advance on the unique identifier table 51D. That is, the server 51 determines whether or not to generate the NFT associated with the received unique identifier, based on the received unique identifier.

If the received unique identifier is not registered, the server 51 makes error judgement (step S73). When the error judgement has been made, the NFT is not generated. If the received unique identifier is registered, the server 51 executes NFT generation in step S74.

The NFT generation in step S74 may include step S74A of acquiring NFT data from the terminal 31 (reader 31). The NFT data acquired in step S74A may include, for example, data relating to the attachment object 530. When the attachment object 530 is sneakers, the data relating to the attachment object 530 is, for example, at least one of the product name, model number, manufacturer, size, price, and image data of the sneakers.

If the NFT data includes data, such as the image data, to be stored in the database 52 (see FIG. 2) outside the blockchain 20, the server 51 stores the image data or the like into the database 52, and acquires a link to the stored data. The link constitutes a part of the NFT data. The received unique identifier may also constitute a part of the NFT data.

The server 51 writes the NFT data into the contract address (e.g., “0x8888” shown in FIG. 1 and FIG. 4) to which an NFT is to be recorded, by using its own blockchain address 25C (see FIG. 1). Due to this writing, an NFT is generated (step S74B). When generation of the NFT has been completed, the terminal 31 (reader) of the first user U1 is notified that generation of the NFT has been completed. Generation of the NFT may be performed by the server 51 calling the smart contract having the contract address (e.g., “0x8888” shown in FIG. 1 and FIG. 4). The called smart contract generates the NFT. The called smart contract may perform both NFT generation and NFT transmission described later.

The NFT registration process 51G may include registering, on the correspondence data table 51E, correspondence data indicating the correspondence between the acquired unique identifier 46, and the token identifier of the NFT generated according to the unique identifier 46. Registration to the correspondence data table 51E may be performed before generation of the NFT, or after generation of the NFT.

The NFT registration process 51G may include notifying the token identifier from the server 51 to the terminal 31. A notification of the token identifier to the terminal 31 may be transmitted together with the NFT generation completion notification, or may be transmitted before generation of the NFT.

The generated NFT is acquired by the first user U1 as the NFT producer. For example, the generated NFT is transmitted to the blockchain address (e.g., “0x9999” in FIG. 1) of the first user U1 as the NFT producer. As an example, the terminal 31 of the first user U1 calls the smart contract 22 to cause the smart contract 22 to transmit the generated NFT to the blockchain address (e.g., “0x9999” in FIG. 1) of the first user U1. The smart contract 22 is called with the blockchain address of the first user U1 being the caller. Calling of the smart contract 22 with the blockchain address of the first user U1 being the caller may be executed by the server 51. Calling of the smart contract 22 may be performed before step S74, or after step S74.

If calling of the smart contract 22 is performed after completion of NFT generation, calling of the smart contract 22 may be performed, for example, when the notification of NFT generation has been received, or when a predetermined time has elapsed after transmission of the unique identifier. The terminal 31 can transmit, to the smart contract 22, the token identifier of an NFT that the terminal 31 desires to transmit. When the NFT to be transmitted from the smart contract 22 is identified by the blockchain address of the first user U1, the terminal 31 need not transmit the token identifier to the smart contract 22.

When the smart contract 22 has been called for transmission of the NFT, the smart contract 22 executes the NFT transmission process 22B, and transmits the generated NFT to the blockchain address as the caller. Through the above processes, the generated NFT is owned on the blockchain address of the first user U1 as the NFT producer. Therefore, the NFT producer owns both the NFC tag 40 and the NFT, and can sell the set of the NFC tag 40 and the NFT as a primary combination product. In addition, the NFT producer can also sell a secondary combination product. In selling the combination product, the NFT may be transmitted to the blockchain address of the purchaser of the combination product.

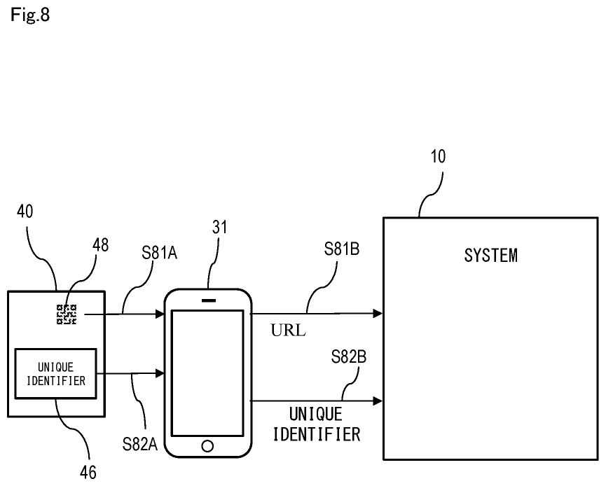

FIG. 8 shows an example of a method for accessing the system 10 on the network 15 in order to, for example, start the registration process 51G or the token operation process 51H. The NFC tag 40 (object 40) shown in FIG. 8 includes a unique identifier, and a code 48 readable by the terminal 31. The object 40 is, as an example, a card having an NFC tag. The code 48 is, for example, a machine-readable code. The code 48 is, as an example, a two-dimensional code. The code 48 indicates data for accessing the system 10. The code 48 indicates, for example, a URL of the system 10. The code 48 is read by, for example, a camera included in the terminal 31. The code 48 being read by the terminal 31 allows a screen of the system 10 to be displayed on the display of the terminal 31.

In the example shown in FIG. 8, before reading of the unique identifier 46, reading of the code 48 is performed. In the following description, reading of the code 48 may be referred to as primary reading, and reading of the unique identifier may be referred to as secondary reading.

Firstly, the terminal 31 performs the primary reading (step S81A). In the primary reading, the code 48 attached to the NFC tag 40 (article 40) is read by the terminal 31. The primary reading allows the terminal 31 to acquire the data, e.g., the URL, for accessing the system 10. The terminal 31 accesses the system 10 on the network 15 by using the read data (URL) (step S81B). The terminal 31 can access the system 10 by, for example, accessing the acquired URL by using a browser of the terminal 31 or another application program. Through the above processes, connection between the terminal 31 and the system 10 is established.

Subsequently, the terminal 32 performs the secondary reading (step S82A). The secondary reading may be performed in the state where the connection between the terminal 31 and the system 10 is maintained. In the secondary reading, the unique identifier 46 of the NFC tag 40 is read by the terminal 31. The terminal 31 transmits the read unique identifier 46 to the system 10 accessed by the terminal 31.

According to the example shown in FIG. 8, transmission of the unique identifier 46 to the system 10 that uses the unique identifier 46, is facilitated. Since the code 48 is visually recognizable by the user while the unique identifier 46 is not always visually recognizable by the user, the code 48 is useful for presenting, to the user, presence of an object to be read.

The unique identifier 46 being transmitted to the system 10 that uses the unique identifier 46, allows the system 10 to perform various processes using the unique identifier 46.

For example, upon receiving the unique identifier 46, the system 10 can generate an NFT. In addition, upon receiving the unique identifier 46, the system 10 can operate an NFT associated with the unique identifier 46. For example, upon receiving the unique identifier 46, the system 10 can transmit the NFT associated with the unique identifier 46 to the blockchain address of the user of the terminal 31.

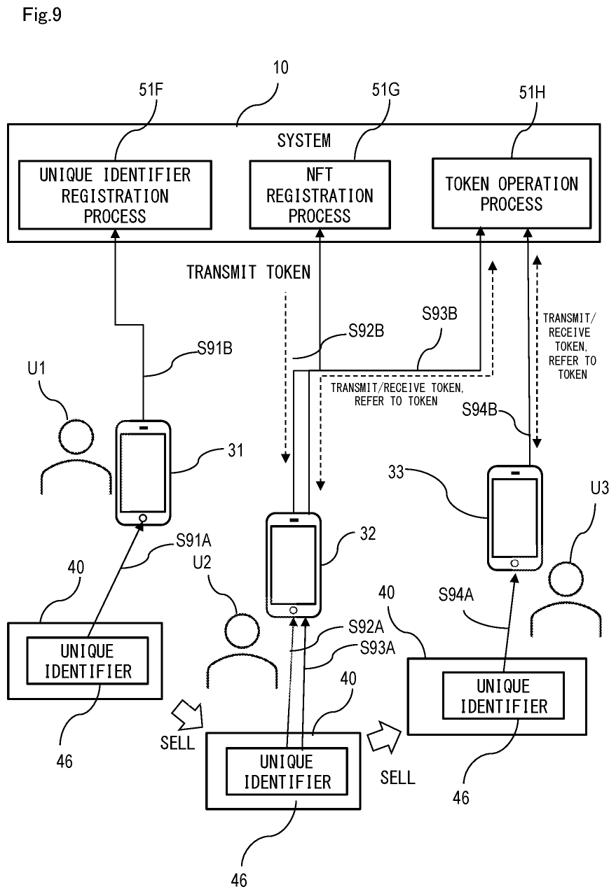

FIG. 9 shows an example of a scenario of the flow of the unique identifier 46 in the procedure of utilization shown in FIG. 5. In FIG. 9, as an example, a user U1 participates in the tag pre-processing S50A, a user U2 participates in the tag non-fungible tokenization S50B, and a user U3 participates in the tag use S50C. In FIG. 9, the user U1 possesses the terminal 31, the user U2 possesses the terminal 32, and the user U3 possesses the terminal 33.

In order to register the unique identifier 46, the user U1 reads the unique identifier 46 by using the terminal 31 (step S91A), and transmits the unique identifier 46 to the system 10 (step S91B). The system 10 executes the unique identifier registration process 51F. Thus, the unique identifier 46 of the NFC tag 40 is registered in the system 10, and becomes usable for NFT operations such as NFT generation. The user U1 sells the NFC tag 40 to the user U2.

In order to acquire the NFT, the user U2 reads the unique identifier 46 by using the terminal 32 (step S92A), and transmits the unique identifier 46 to the system 10 (step S92B). The system 10 executes the NFT registration process 51G. The generated NFT is transmitted to the blockchain account of the user U2. Thus, the user U2 can acquire the NFT. The NFT acquired by the user U2 is displayed on the terminal 32.

The user U2 having acquired the NFT reads the unique identifier 46 by using the terminal 32 in order to transmit the NFT or refer to the NFT (step S93A), and transmits the unique identifier 46 to the system 10 (step S93B). The system 10 having received the unique identifier 46 in step S93B executes the token operation process 51H.

The user U2 can sell the NFC tag 40 to the user U3. In this case, through steps S93A, S93B and the token operation process 51H, the NFT associated with the unique identifier may be transmitted from the blockchain account of the user U2 to the contract address of the smart contract 22. Thus, the smart contract 22 keeps the NFT.

The user U3 having purchased the NFC tag 40 reads the unique identifier 46 by using the terminal 33 in order to acquire the NFT (step S94A), and transmits the unique identifier 46 to the system 10 (step S94B). The system 10 executes the token operation process 51H. The generated NFT is transmitted to the blockchain account of the user U3. Thus, the user U3 having purchased the NFC tag 40 can acquire the NFT associated with the NFC tag 40. That is, the user U3 can purchase the combination product of the NFC tag 40 and the NFT. The NFT acquired by the user U3 is displayed on the terminal 33.

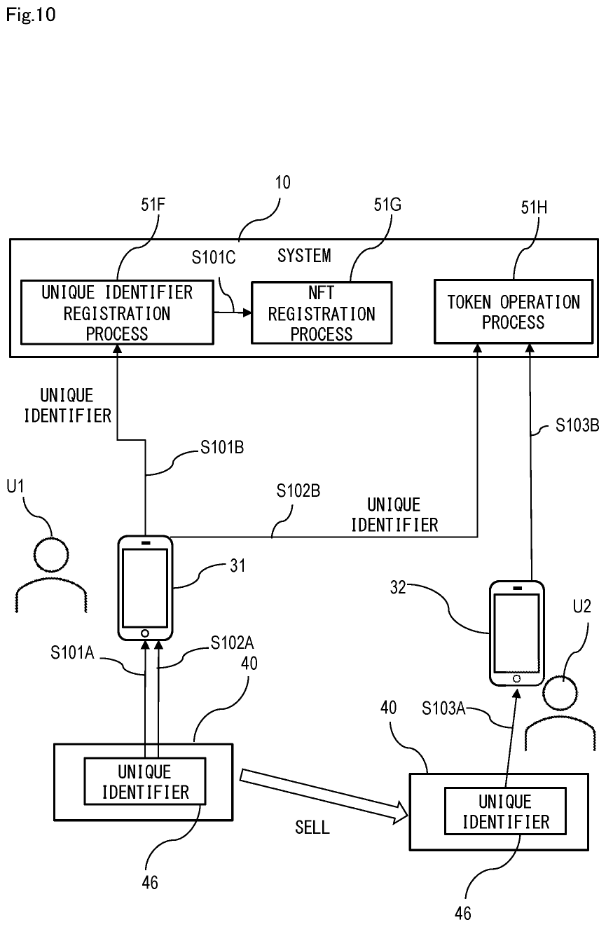

FIG. 10 shows another example of the scenario of the flow of the unique identifier 46. In FIG. 10, as an example, the user U1 participates in both the tag pre-processing S50A and the tag non-fungible tokenization S50B, and the user U2 participates in the tag use S50C. In FIG. 9, the user U1 possesses the terminal 31, and the user U2 possesses the terminal 32.

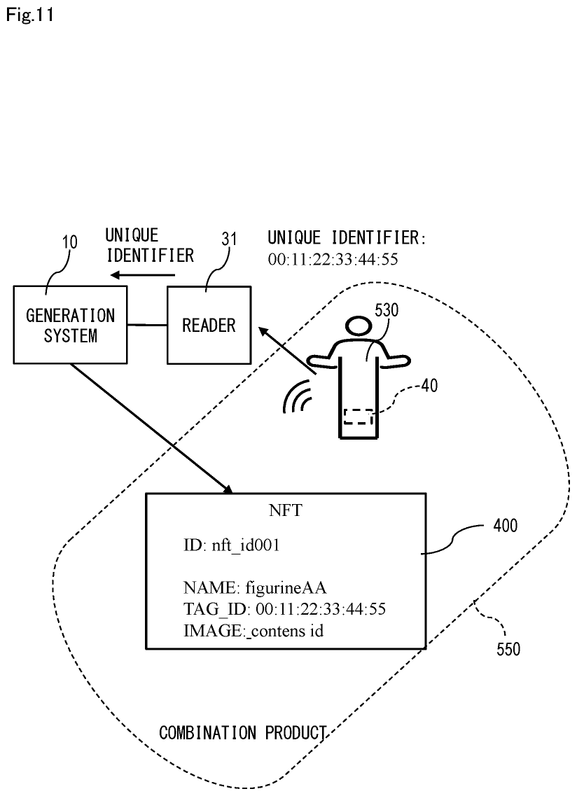

In the example shown in FIG. 10, the attachment object 530 to which the NFC tag 40 is attached is already present, but the unique identifier of the NFC tag 40 is not yet registered in the system 10. In the example shown in FIG. 10, an NFT 400 associated with the attachment object 530 having the unregistered NFC tag 40 can be generated as shown in FIG. 11. That is, a combination product of the attachment object 530 and the NFT 400 can be obtained.

The attachment object 530 to which the NFC tag 40 is attached is, for example, a figure having the NFC tag 40 embedded therein. The figure may be a figurine. The figure 530 is, for example, a figure of a character that appears in a novel, comic, animation, game, etc., an animal, a plant, a vehicle, a machine, a tool, or a weapon. The attachment object 530 may be a card.

For example, the attachment object 530 is read by equipment (e.g., a game machine or a smartphone) capable of reading the NFC tag 40, and is used for causing a character or an item associated with the attachment object 530 in advance, to appear in a virtual space such as a game space. Such an attachment object 530 may be a figure having a shape according to the character or the item that appears in the virtual space, or may be a card on which the character or the item that appears in the virtual space is drawn. The game is, for example, a blockchain game.

In the example shown in FIG. 10, as described above, the NFC tag 40 alone, whose unique identifier is not yet registered, is made usable for NFT operations such as NFT generation. Alternatively, the NFC tag 40 (whose unique identifier is not yet registered), which is already possessed by the attachment object 530 that is formed for a purpose other than NFT operations such as NFT generation, is made usable for NFT operations such as NFT generation.

In FIG. 10, firstly, the user U1 who possesses the NFC tag 40 or the attachment object 530 to which the NFC tag 40 is attached, reads the unique identifier 46 by using the terminal 31 in order to register the unique identifier 46 (step S101A), and transmits the unique identifier 46 to the system 10 (step S101B). The system 10 executes the unique identifier registration process 51F. Thus, the unique identifier 46 of the NFC tag 40 is registered in the system 10, and becomes usable for NFT operations such as NFT generation. The system 10 further executes the NFT registration process 51G to generate an NFT (step S101C). The generated NFT is transmitted to the user U1. The system 10 having received the unique identifier 46 may firstly execute the NFT registration process 51G and thereafter execute the unique identifier registration process 51F, or may execute these processes 51F, 51G in parallel.

The user U1 sells the NFC tag 40 or the attachment object 530 to which the NFC tag 40 is attached, to the user U2. In selling the tag 40 or the object 530, the user U1 can read the unique identifier 46 by using the terminal 31 (step S102A), and transmit the unique identifier 46 to the system 10 (step S102B). Upon receiving the unique identifier 46 through step S102B, the system 10 executes the token operation process 51H. As a result, an NFT associated with the unique identifier is transmitted from the blockchain account of the user U1 to the contract address of the smart contract 22. Thus, the smart contract 22 keeps the NFT.

The user U2 having purchased the NFC tag 40 reads the unique identifier 46 by using the terminal 32 in order to acquire the NFT (step S103A), and transmits the unique identifier 46 to the system 10 (step S103B). The system 10 executes the token operation process 51H. The generated NFT is transmitted to the blockchain account of the user U2. Thus, the user U2 having purchased the NFC tag 40 or the attachment object 530 to which the NFC tag 40 is attached can acquire the NFT associated with the NFC tag 40. That is, the user U2 can purchase the combination product 550 of the attachment object 530 and the NFT 400 (see FIG. 11). The NFT acquired by the user U2 is displayed on the terminal 32.

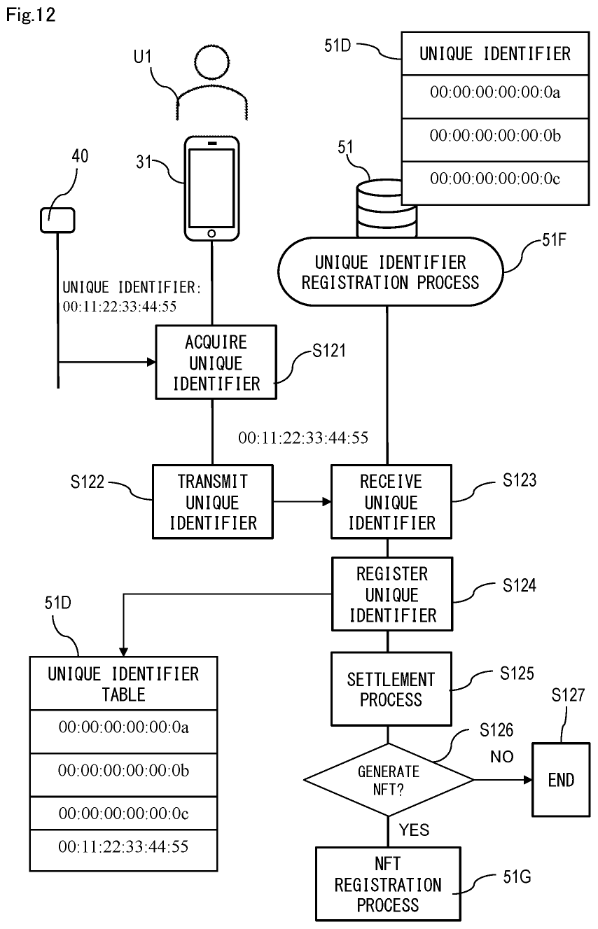

FIG. 12 shows an example of the unique identifier registration process 51F suitable for the scenario shown in FIG. 10. In the scenario shown in FIG. 12, a new unique identifier “00:11:22:33:44:55” is registered on the unique identifier table 51D. At a time point before execution of the unique identifier registration process 51F shown in FIG. 12, the unique identifier “00:11:22:33:44:55” is not yet registered on the unique identifier table 51D.

The terminal 31 acquires the unique identifier “00:11:22:33:44:55” (step S121), and transmits the unique identifier to the system 10 (step S122). The server 51 of the system 10 receives the unique identifier (step S123), and registers the same (step S124). The received unique identifier “00:11:22:33:44:55” is additionally registered on the unique identifier table 51D. Thus, the unique identifier “00:11:22:33:44:55” is registered in the system 10.

Subsequently, the system 10 performs a settlement process for payment of a registration cost (step S125). The settlement process may be performed before the registration in step S124, or may be performed after the NFT registration process 51G. The settlement process allows registration of the unique identifier to be provided as a paid service. If the registration of the unique identifier is a free service, the settlement process may be omitted. The settlement process is performed by, for example, credit card settlement, payment by electronic money, payment by points, or payment by fungible tokens. Most of the settlement process may be performed by another server for settlement different from the server 51. In this case, the server 51 may execute, as the settlement process, a process of entrusting the settlement to the other server.

When registration in step S124 has been completed, the server 51 determines whether or not to generate an NFT (step S126). Whether or not to generate an NFT after registration in step S124 may be left to the intention of the user U1, for example. For example, upon receiving a user operation to generate an NFT, the server 51 can execute the NFT registration process 51G to generate the NFT. Otherwise, the server 51 ends the process without performing the NFT registration process 51G (step S127).

Determination in step S126 may be omitted, and an NFT may be generated subsequently to registration of the unique identifier in step S124. The unique identifier may be registered after generation of an NFT. Generation of an NFT itself may be omitted.

The system 10 may be configured to execute the NFT registration process 51G upon receiving the unique identifier. In this case, the system 10 may generate an NFT corresponding to the unique identifier without performing registration of the unique identifier. That is, in FIG. 12, step S124 may be omitted. Using the settlement process S125 allows the system 10 to provide, as a paid service, production of an NFT corresponding to the received unique identifier.

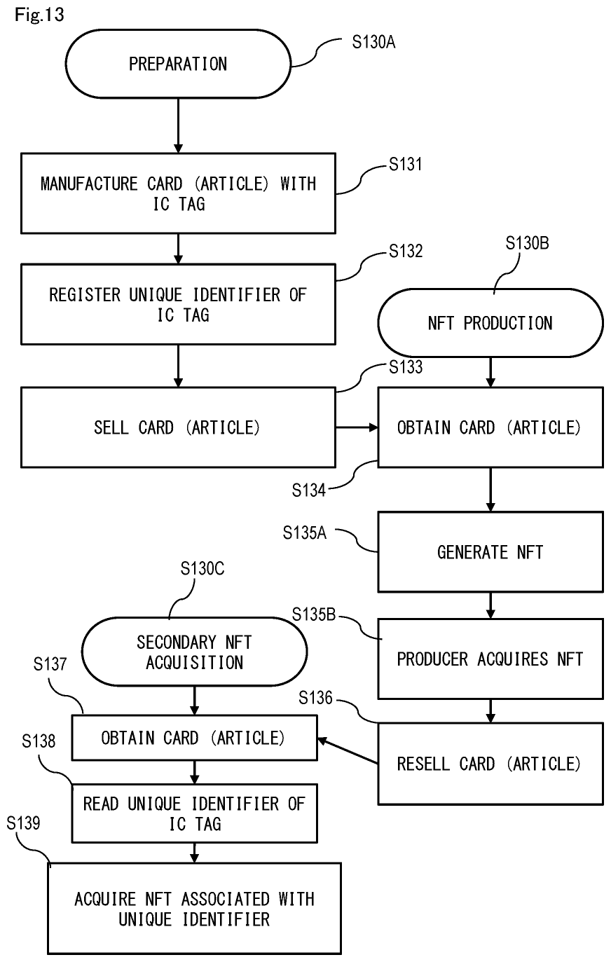

FIG. 13 shows an outline of another example of a procedure for utilizing an object (article) having an integrated circuit. The procedure shown in FIG. 13 includes: preparation S130A, NFT production S130B (primary NFT acquisition) using an article; and secondary NFT acquisition S130C. The description regarding FIG. 1 to FIG. 12 can be applied to the points not particularly described in detail in the description for FIG. 13 and subsequent figures.

Here, as an example, the article having the integrated circuit is a card including an IC tag such as an NFC tag. The card is, for example, a trading card or a digital item selling card. The card is formed by, for example, attaching an IC tag to a card body (attachment object) made of paper or plastic. For example, characters and images are printed on the card body. The IC tag is, for example, pasted to or embedded in the card body.

The following description will be given for a case where an NFT to be generated or operated by an article having an integrated circuit is an NFT that is obtained by non-fungible tokenizing digital data of a character, an item, etc., to be used in a game such as a blockchain game. That is, the NFT is a game NFT associated with the digital data for the game. On the card used for acquiring the game NFT, an image, etc., indicating the digital data (e.g., the game character or the game item) associated with the acquirable game NFT, is printed. This card is an actual item, and therefore is easily purchased and sold through legal currency. Here, as an example, the card as an actual item is used for sale of a digital item.

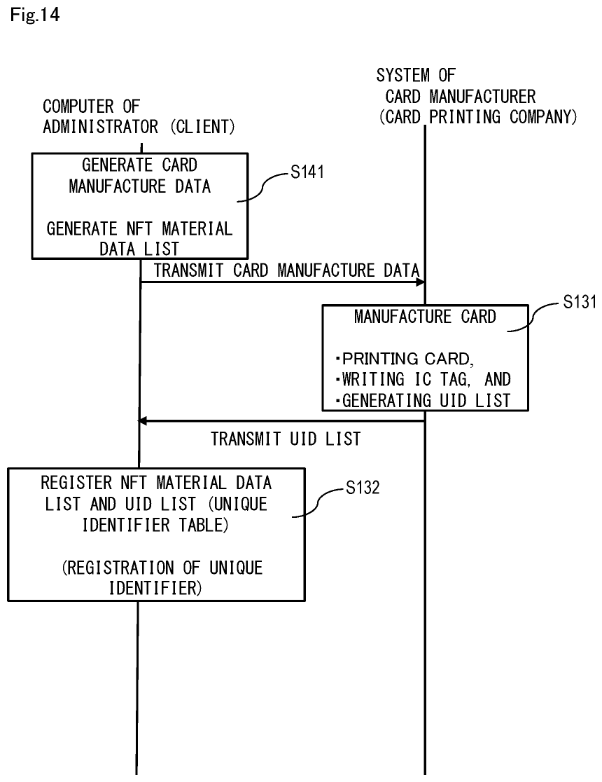

The preparation S130A shown in FIG. 13 includes: a card manufacturing process (step S131); and a registration process for a unique identifier possessed by the IC tag of the card (step S132). FIG. 14 shows examples of the manufacturing process in step S131, the registration process in step S132, and relevant processes.

In FIG. 14, as an example, an administrator and a card (article) manufacturer appear. The administrator may be the administrator of the system 10. The administrator may be a client who asks the card manufacturer to manufacture a card. The administrator may be a seller of the card. The card manufacturer may be, for example, a printing company that manufactures the card by printing. The administrator may also be the card manufacturer.

As shown in FIG. 14, the administrator generates card manufacture data 60 and a material data list 70 to be used for NFT generation, by using a computer of the administrator (step S141).

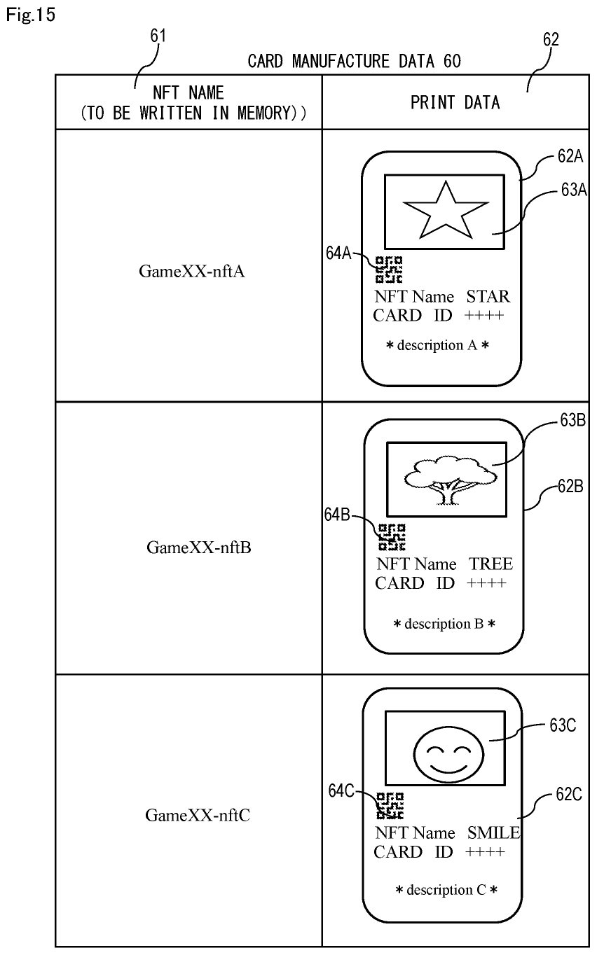

The card manufacture data 60 (article manufacture data) includes data to be added to the card (article) to be manufactured. FIG. 15 shows an example of the card manufacture data 60. The card manufacture data 60 is configured such that first data 61 to be written in a memory of an integrated circuit (IC tag) included in a card is associated with second data 62 (print data 62) for printing onto the card in which the first data 61 is to be written. The pair of the data 61, 62 associated with each other in the card manufacture data 60 is given to the same card. In the card manufacture data 60, each of a plurality of first data is associated with the second data 62.

In FIG. 15, as an example, the first data 61 is indicated as “NFT Name (to be written in memory)”. In FIG. 15, as “NFT Name (to be written in memory)”, three names, “GameXX-nftA”, “GameXX-nftB”, and “GameXX-nftC”, are registered. The first data 61 written in the memory may be read out by the reader, and transmitted to the system 10. Upon receiving the first data 61, the system 10 may identify generation data to be used for generating an NFT, based on the received first data 61. The system 10 may identify an NFT to be operated, based on the received first data 61.

The second data 62 as the print data includes, for example, data of images and characters to be printed on the card body. The printed card indicates digital data of a character, an item, etc., possessed by the NFT to be acquired by using the card. For example, the second data 62 may include image data 63A, 63B, 63C of characters, items, etc., of the game. As an example, each of the image data 63A, 63B, 63C is image data of a character or an item possessed by the NFT to be generated by using the corresponding card. FIG. 15 shows the image data 63A of “STAR”, the image data 63B of “TREE”, and the image data 63C of “SMILE”, as examples of characters and items.

The second data 62 may include the name of the character or the item (NFT name) possessed by the NFT to be generated by using the card. In the print data 62 shown in FIG. 15, the name is indicated as “NFT Name”. For example, the “NFT Name” is “STAR” in the print data 62A associated with “GameXX-nftA”, the “NFT Name” is “TREE” in the print data 62B associated with “GameXX-nftB”, and the “NFT Name” is “SMILE” in the print data 62C associated with “GameXX-nftC”.

In addition, the second data 62 may include descriptions of the characters and the items indicated by the image data 63A, 63B, 63C or the “NFT NAME”. In FIG. 15, the descriptions are omitted, and *descriptionA*, *descriptionB*, *descriptionC* are shown instead of the descriptions.

The second data 62 may have machine-readable codes 64A, 64B, 64C. The codes 64A, 64B, 64C are, for example, two-dimensional codes. The codes 64A, 64B, 64C indicate data for accessing the system 10. The codes 64A, 64B, 64C indicate, for example, the URL of the system 10. The codes 64A, 64B, 64C are, for example, read by cameras included in the corresponding terminals. The codes 64A, 64B, 64C being read by the terminals allow the screen of the system 10 to be displayed on the displays of the terminals. Since the functions of the codes 64A, 64B, 64C are identical to the function of the code 48 shown in FIG. 8, the description with respect to FIG. 8 is applied here. The contents of the plurality of codes 64A, 64B, 64C may be the same, or may be different from each other.

The second data 62 may have characters “CARD ID”. The “CARD ID” indicates that characters, numerals, etc., following the same represent a card type identifier (object identifier) described later.

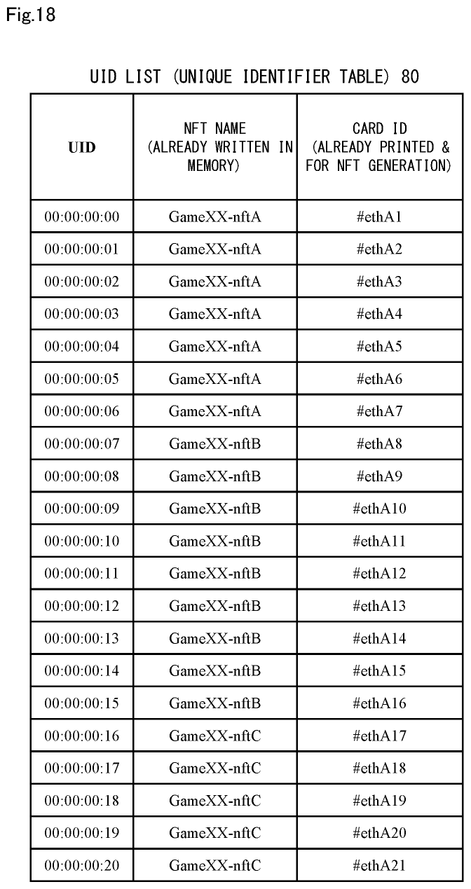

Each of the second data 62A, 62B, 62C described above may be common print data to be commonly used for printing of a plurality of cards. Meanwhile, the print data may include individual data that vary from card to card, in addition to the second data 62 as the common print data. The individual data may be, for example, card identifiers (object identifiers) that make the respective cards unique. The card identifiers may be configured as serial numbers assigned in the printing order, or may be configured to have the serial numbers. Even when the cards have different individual data, printing is facilitated if the individual data are (or have) the serial numbers. As an example, a card identifier is printed in an area represented by “++++” in FIG. 15 (“++++” is not the printed data, but indicates the area where the card identifier is printed). The card identifier may be generated by a generator 700 (see FIG. 18). The generated card identifier may be printed simultaneously with the common print data, or may be printed before or after printing of the common print data.

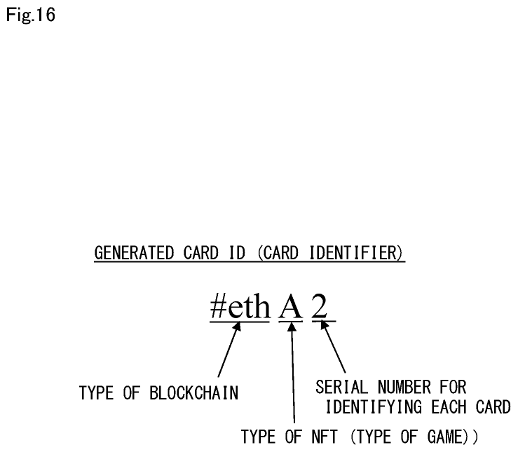

FIG. 16 shows an example of the card identifier (object identifier) generated by the generator 700. The card identifier shown in FIG. 16 includes, as an example, the type of a blockchain on which an NFT corresponding to the card is recorded, the type of the NFT corresponding to the card, and a serial number for identifying the card.

In FIG. 16, the card identifier includes characters “#eth” indicating the type of the blockchain. As an example, “#eth” indicates that the blockchain is Ethereum. The card identifier indicating the type of the blockchain allows the system 10, which is given the card identifier, to identify the type of the blockchain on which the NFT corresponding to the card is recorded.

In FIG. 16, the card identifier includes a character “A” indicating the type of the NFT. As an example, “A” indicates the type of a game in which the NFT corresponding to the card is used. That is, the character “A” may indicate the type of the NFT, i.e., that the NFT is for the game “A”. The type of the NFT may be regarded as the type of the smart contract that manages the NFT. That is, the character “A” may be a contract identifier indicating the smart contract “A”. The system 10, to which the contract identifier is given, can identify the smart contract that manages the NFT corresponding to the card.

In FIG. 16, the card identifier includes a numeral “2” that is an example of a serial number for identifying the card. As an example, “2” indicates that the corresponding card is the second card printed as a card having a card identifier including “#ethA”. This serial number makes each of a plurality of cards, whose card identifiers include “#ethA”, unique.

The card identifier (object identifier) may be given to the system 10 from the user terminal or the like, and used by the system 10 to identify the NFT associated with the card. The system 10 may have correspondence data between a card identifier and an NFT corresponding to the card identifier. The system 10 can operate the NFT identified based on the card identifier with reference to the correspondence data. The operation on the NFT is, for example, referring to information possessed by the NFT, or transmitting/receiving the NFT. For example, the user having transmitted the card identifier to the system 10 can refer to the information on the NFT (e.g., the owner of the NFT) corresponding to the card. In addition, the card identifier given to the system 10 may be used by the system 10 to identify generation data to be used for generating an NFT. The system 10 may generate an NFT by using the identified generation data.

The card manufacture data 60 (article manufacture data) shown in FIG. 15 also serves as manufacture instruction data to the card manufacturer. That is, the data 60 in FIG. 15 indicates that “GameXX-nftA” should be written in the memory included in the card on which the print data 62A is printed, indicates that “GameXX-nftB” should be written in the memory included in the card on which the print data 62B is printed, and indicates that “GameXX-nftC” should be written in the memory included in the card on which the print data 62C is printed. As shown in FIG. 14, the generated card manufacture data 60 is transmitted to the system of the card manufacturer (e.g., the system performing printing and writing into memory). The system of the card manufacturer prints the card and writes the IC tag into a memory, according to the data 60 (step S131 in FIG. 13 and FIG. 14). Each of the print data 62A, 62B, 62C is commonly used for printing of a plurality of cards. For example, the print data 62A is commonly used for printing of 1000 cards. Therefore, the administrator who instructs manufacture of cards need not create a large quantity of card manufacture data 60.

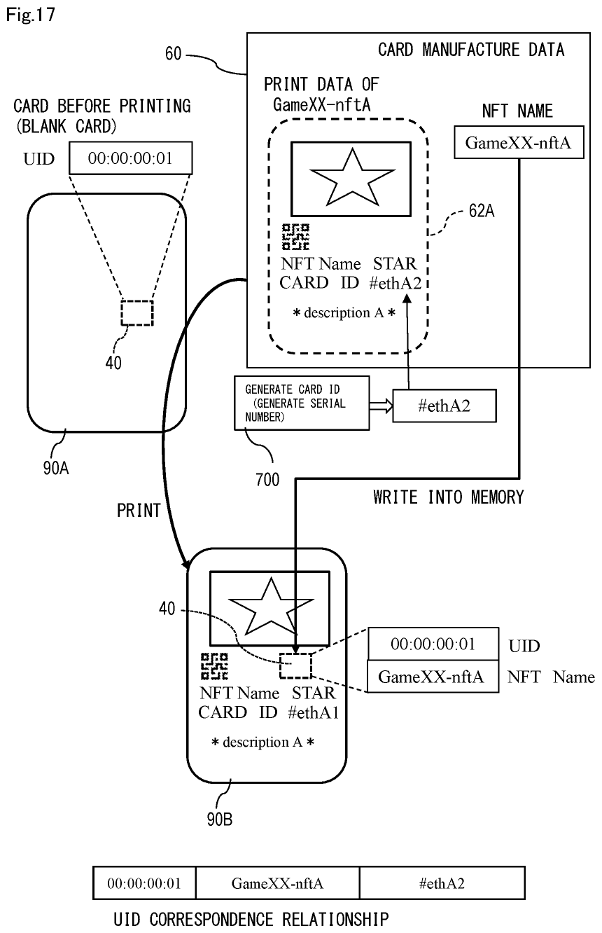

FIG. 17 shows an outline of card printing, writing into memory, and UID list generation in step S131 shown in FIG. 14. The system of the card manufacturer includes a printer, and a reader/writer for the IC tag 40. The printer prints, on a blank card 90A, the print data 62A included in the card manufacture data 60.

The card 90A includes the IC tag 40. The unique identifier (UID) has been recorded in advance in the memory of the IC tag 40. Here, an example of the UID is “00:00:00:01”. The IC tag 40 has been attached in advance to the card 90A before printing, but may be attached to a printed card 90B.

The reader/writer writes “NFT NAME” included in the card manufacture data 60 into the memory. The reader/writer may also be used for reading the unique identifier (UID) of the IC tag 40.

Here, as an example, in the card manufacture data 60 shown in FIG. 15, the print data 62A associated with NFT Name: “GameXX-nftA” is printed on the card 90A by the printer, and NFT Name: “GameXX-nftA” is written in the memory of the card 90A by the reader/writer. The system of the card manufacturer reads the unique identifier (UID) of the IC tag in which “GameXX-nftA” is recorded, and stores the same. For example, when writing NFT Name: “GameXX-nftA” into the memory of the card 90A (simultaneously with the writing or before or after the writing), the system of the card manufacturer reads the unique identifier stored in the memory, and stores the read unique identifier in association with the written NFT NAME. In addition, the system stores the unique identifier read from the card, in association with the card identifier assigned to the card.

Here, as an example, the generator 700 generates “#ethA2” as a card identifier (CARD ID), and this card identifier is printed on the card 90A together with the print data 62A.

The card 90B obtained through the printing and writing has an image corresponding to the print data 662A, and the card identifier as shown in FIG. 17. Also, in the memory of the card 90B, the unique identifier (UID) of the IC tag 40 is recorded, and “GameXX-nftA” is recorded as the NFT Name.

The card manufacturer or the system of the card manufacturer manufactures the card 90B as described above, and therefore grasps the correspondence relationship (UID correspondence relationship) between the UID, and the NFT Name recorded in the memory of the card 90B having the UID. In addition, the system of the card manufacturer grasps the correspondence relationship (UID correspondence relationship) between the UID, and the card identifier assigned to the card 90B having the UID. The system generates a UID list in which these correspondence relationships are shown for each of a plurality of UIDs.

FIG. 18 shows an example of the generated UID list 80 (unique identifier table 80). The UID list shown in FIG. 18 shows correspondence between a unique identifier (UID) of an IC tag 40, NFT NAME written in the IC tag 40, and a card identifier (CARD ID) printed on a card having the IC tag. As shown in FIG. 14, the UID list 80 shown in FIG. 18 is transmitted from the system of the card manufacturer to the system 10 of the administrator, and is registered in the system 10 (step S132). The UID list 80 is registered in, for example, the server 51 shown in FIG. 2. In the system 10, the registered UID list 80 may be used in the same way as the unique identifier table 51D shown in FIG. 3. That is, the card 90A including the IC tag 40 having the unique identifier included in the UID list 80 is registered in the system 10 so as to be used for NFT generation or operation. The system 10 transmits the card manufacture data 60 to the system of the card manufacturer, and receives the UID list 80 returned after manufacture of a card, whereby the system can readily register the unique identifier of the manufactured card.

The UID list 80 shown in FIG. 18 is not just a list of unique identifiers, but shows the correspondence relationship between the NFT Name written in the memory and the printed card identifier, and therefore can also be used by the system 10 to grasp the correspondence relationship.

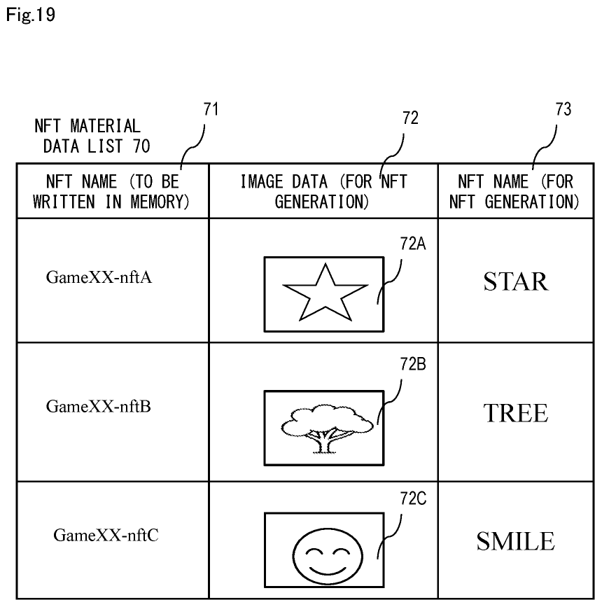

Referring back to FIG. 14, in step S141, not only the card manufacture data 60 but also a material data list 70 used for NFT generation is generated. FIG. 19 shows an example of the material data list 70 corresponding to the card manufacture data 60. The material data list 70 is configured such that each data 71 (NFT Name) written in the memory of the IC tag 40 is associated with data 72, 73 used for NFT generation. For example, “GameXX-nftA” is associated with image data 72A as material data for NFT generation, and character data “STAR” as material data. Furthermore, “GameXX-nftB” is associated with image data 72B as material data for NFT generation, and character data “TREE” as material data. Moreover, “GameXX-nftC” is associated with image data 72C as material data for NFT generation, and character data “SMILE” as material data.

The card manufacture data 60 shown in FIG. 15 and the material data list 70 shown in FIG. 19 are associated with each other by “NFT Name” written in the memory. For example, the print data 62A associated with “GameXX-nftA” in the card manufacture data 60 shown in FIG. 15 corresponds to the image data 72A and the character data “STAR” associated with “GameXX-nftA” in FIG. 19.

As described above, the image data 63A included in the print data 62A and the image data 72A to be non-fungible tokenized have a correspondence relationship. The image data 63A, 72A having the correspondence relationship are images that are common or similar to each other to an extent that a person who views the images recognizes that the image data 63, 72 represent the same object (character, item, etc.). Therefore, an NFT that is generated or operated by using the card on which the print data 62A is printed has an image that is common or similar to the card.

The NFT Name “STAR” included in the print data 62A and “STAR” as an NFT Name 73 to be non-fungible tokenized have a correspondence relationship. These NFT Names having the correspondence relationship are the same character data to an extent that a person who views them recognizes that the names are common or similar to each other. Therefore, an NFT that is generated or operated by using the card on which the print data 62A is printed has characters (name) that are common or similar to the card.

The UID list 80 shown in FIG. 18 and the material data list 70 shown in FIG. 19 are associated with each other by “NFT Name” written in the memory. For example, in the UID list 80 shown in FIG. 18, UID “00:00:00:01” associated with “GameXX-nftA” corresponds to the image data 72A and the character data “STAR” that are associated with “GameXX-nftA” in FIG. 19.

The material data list 70 shown in FIG. 19, which has been generated in step S141 in FIG. 14, is registered in the system 10 (step S132). The material data list 70 is registered in, for example, the server 51 shown in FIG. 2. The material data list 70 is registered in the system 10 together with the aforementioned UID list 80. The material data list 70 shows material data (NFT generation data) to be used for generating NFTs corresponding to the unique identifiers (UIDs) shown in the UID list 80. For example, upon receiving UID “00:00:00:01” in the UID list 80 shown in FIG. 18, the system 10 recognizes, as NFT generation data, the image data 72A and the character data “STAR” shown in FIG. 19 among the material data shown in the material data list 70, and generates an NFT corresponding to the UID “00:00:00:01” by using the NFT generation data.

The material data included in the material data list 70 may be used for generating a plurality of NFTs corresponding to a plurality of unique identifiers (UID) included in the UID list 80 shown in FIG. 18. For example, in the UID list 80 shown in FIG. 18, seven UIDs from “00:00:00:00” to “00:00:00:06” are associated with the image data 72A and the character data “STAR” shown in FIG. 19, via the NFT Name: “GameXX-nftA”. Therefore, the respective NFTs corresponding to the UIDs “00:00:00:00” to “00:00:00:06” are generated with the image data 72A and the character data “STAR” shown in FIG. 19 being the common NFT generation data. In order to allow the user to easily distinguish the NFTs having the common NFT generation data (the image data 72A and the character data “STAR” shown in FIG. 19) from each other, card identifiers (see FIG. 18) identical to the card identifiers (CARD) printed on the actual cards may be used as NFT generation data.

When registration in step S132 shown in FIG. 13 and FIG. 14 has been completed, the card 90B manufactured in step S131 functions as a card usable for NFT generation or NFT operation. This card 90B (article) is sold or transferred (step S133 in FIG. 13).

The purchaser (producer) of the card 90B (article) may perform NFT production (NFT generation) (step S130B). The purchaser can obtain the card 90B as an actual item by paying legal currency, that is, can obtain the card 90B even if the purchaser does not have crypto assets. The purchaser, who has purchased the card 90B (step S134), reads the unique identifier (and the NFT Name according to need) of the IC tag 40 of the card, with the reader 31 (terminal). The read NFT Name may be used in the system 10, as data for identifying the NFT generation data or data for identifying the NFT to be operated. The read unique identifier and data are transmitted from the reader 31 to the system 10 via the network 15. The unique identifier and data transmitted to the system 10 are received by the system 10. The unique identifier and data may be received by, for example, the server 51.

Upon acquiring the unique identifier, the system 10 generates (produces) an NFT 400 (step S135). The generated NFT 400 is acquired by the user who is the purchaser of the card (step S135B). The user can play a blockchain game or the like by using digital data for the game corresponding to the generated NFT 400.

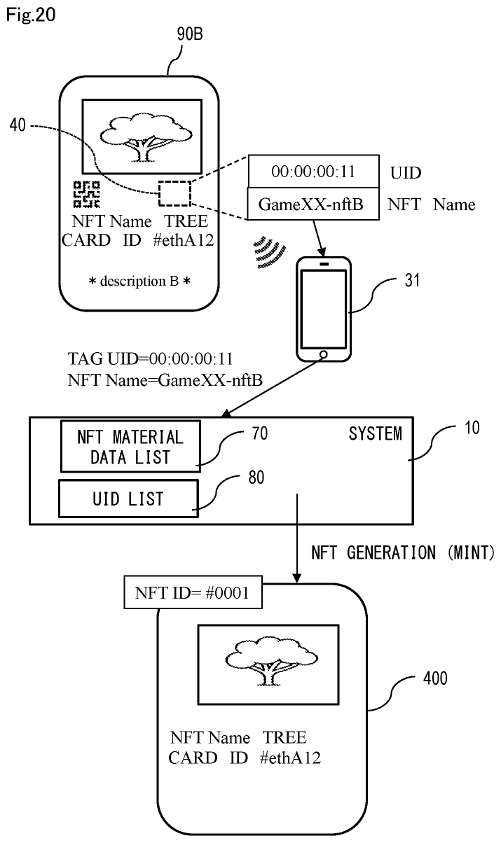

FIG. 20 shows an example of a procedure of NFT generation in step S135. The following description will be given for a case of generating an NFT by using the card 90B (see FIG. 20) including the IC tag 40 having UID: “00:00:00:11” and NFT Name: “GameXX-nftB” shown in the UID list 80 in FIG. 18. In the following description, processes executed by the system 10 may be executed by, for example, the server 51 or the smart contract 22.

The system 10 receives the UID: “00:00:00:11” of the card 90B, and receives, according to need, the NFT Name: “GameXX-nftB”. The system 10 determines whether or not the received UID is registered in the UID list 80. That is, the system 10 determines whether or not the received UID is a unique identifier that is registered in advance in the UID list 80 being the unique identifier table. If the received UID is registered in the UID list 80, the system 10 generates an NFT.

Furthermore, the system 10 identifies NFT generation data to be used for generating the NFT corresponding to the received UID, from the material data list 70 (from among the plurality of material data) provided in the system 10.

For example, the NFT generation data is identified, based on the received UID, with reference to the UID list 80 and the NFT material data list 70. Here, the UID list 80 and the NFT material data list 70 are an example of the correspondence data between the UID (unique identifier) and the generation data (material data). For example, as shown in FIG. 20, when the received UID is “00:00:00:11”, the system 10 grasps that the NFT Name corresponding to the UID: “00:00:00:11” is “GameXX-nftB”, based on the received UID, with reference to the UID list 80. The system 10 may confirm whether or not “GameXX-nftB” grasped as the NFT Name corresponding to the received UID: “00:00:00:11” matches the received NFT Name. If the NFT Name grasped based on the received UID does not match the received NFT name, the system 10 may determine that an error has occurred, and suspend generation of the NFT. That is, the NFT is generated when the NFT Name grasped from the received UID matches the received NFT Name.

The system 10 grasps that the CARD ID (for NFT generation) corresponding to the UID: “00:00:00:11” is “#ethA12”, based on the received UID, with reference to the UID list 80.

The system 10 grasps that the material data (NFT generation data) corresponding to the NFT Name: “GameXX-nftB” includes the image data 72B and the character data “TREE”, based on the grasped NFT Name: “GameXX-nftB”, with reference to the material data list 70.

As described above, the system 10 can recognize that the NFT generation data corresponding to the UID: “00:00:00:11” includes the image data 72B, the character data “TREE”, and “#ethA12”. The NFT generation data may include other data, for example, the received UID.

The system 10 may identify at least a part of the NFT generation data, based on the received NFT Name (the data received by the system 10 in order to identify the NFT generation data). For example, the system 10 may identify the image data 72B and the character data “TREE” as the NFT generation data corresponding to the received NFT Name: “GameXX-nftB”, based on the received NFT Name: “GameXX-nftB”, with reference to the material data list 70. The system 10 may identify “#ethA12” as the NFT generation data, based on the received UID.

Using at least the identified NFT generation data, the system 10 generates (MINT) an NFT 400 having the NFT generation data. For example, “#0001” is given to the generated NFT 400, as a token identifier (NFT_ID). This NFT identifier is recorded on the blockchain in order to identify the NFT on the blockchain.

According to the above NFT generation process, since the NFT is generated with the material data included in the system 10 being used as the NFT generation data, a plurality of NFTs having the common NFT generation data can be easily generated in large quantities. Moreover, the user as the NFT producer need not transmit the NFT generation data to the system 10, thereby reducing the burden on the NFT producer.

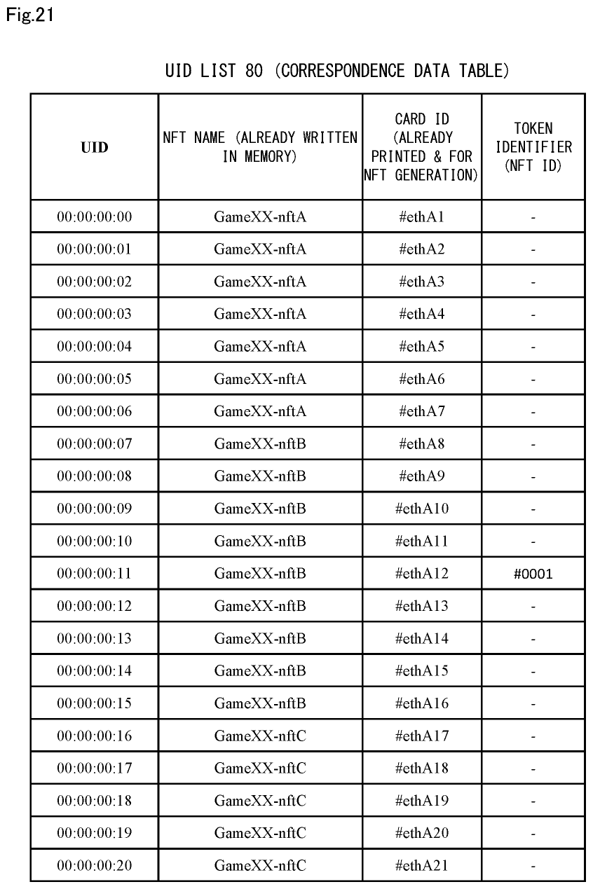

The system 10 may store therein correspondence data between a UID and a token identifier corresponding to the UID. For example, as shown in FIG. 21, the system 10 may store, in the UID list 80, token identifiers corresponding to the UIDs. In FIG. 21, a token identifier (NFT_ID): “#0001” is stored in association with UID: “00:00:00:11”. The UID list 80 shown in FIG. 21 may function in the same way as the correspondence data table 51E shown in FIG. 3. Since the correspondence data indicating the correspondence between the unique identifier of the IC tag 40 and the token identifier of the NFT is registered, the generated NFT can be associated with the unique identifier. Since the correspondence relationship between the card 90B (IC tag 40) and the NFT 400 is registered in the UID list 80 being the correspondence data table, the card 90B having the unique identifier can be used for NFT operations.

For example, as shown in FIG. 13, the card 90B may be resold (step S136) to be acquired by a secondary acquirer (step S130C, S137). Resale of the card as an actual item can be performed with legal currency through a resale site. The secondary acquirer of the card 90B reads the unique identifier of the card 90B with a terminal, and transmits the unique identifier to the system 10, thereby acquiring the NFT 400 corresponding to the card 90B.

The present invention is not limited to the above embodiment, and various modifications can be made.

### REFERENCE SIGNS LIST

10 system
15 network
20 blockchain
22 smart contract
22A generation process
22B NFT transmission process
22C operation process
25A blockchain address
25B blockchain address
25C blockchain address
31 terminal (reader)
31A processor
31B storage device
31C computer program
31D near field communication module
31E private key
32 terminal (reader)
32D near field communication module
33 terminal
40 object (NFC tag)
40A tag body
40B cable tie
41 antenna
42 radio circuit
43 controller
44 memory (non-volatile memory; read only memory)
46 unique identifier
48 code
51 server
51A processor
51B storage device
51C computer program
51D unique identifier table
51E correspondence data table
51F unique identifier registration process
51G NFT registration process (NFT production process)
51H token operation process
51J private key
52 database
60 card manufacture data
61 first data
62 second data (print data)
62A print data
62B print data
62C print data
63 image data
63A image data
63B image data
63C image data
64A two-dimensional code
64B two-dimensional code
64C two-dimensional code
70 material data list
72 image data
72A image data
72B image data
72C image data
80 UID list (unique identifier table; correspondence data table)
90A card (object; article)
90B card (object; article)
410 NFT data
500 image data
510 primary combination product
520 secondary combination product
530 attachment object
550 combination product
U1 user
U2 user
U3 user

1. A production method executed by a system that produces a non-fungible token to be recorded on a blockchain, the method comprising:
receiving a unique identifier possessed by an object;
determining whether or not the received unique identifier is an already-registered unique identifier that has been registered in the system in advance; and
generating a non-fungible token if the received unique identifier is determined to be the already-registered unique identifier, wherein generating the non-fungible token is executing, by the system, at least one of processes (1) and (2) as follows:
(1) a process including generating a non-fungible token having the unique identifier; and
(2) a process including generating a non-fungible token, such generating the non-fungible token including recording, on the blockchain or a computer outside the blockchain, correspondence between the non-fungible token and the unique identifier.

2. The production method according to claim 1, wherein
the object includes an integrated circuit; and
the unique identifier is a unique identifier of the integrated circuit.

3. The production method according to claim 1 further comprising identifying generation data to be used for generating the non-fungible token, from among a plurality of material data that are possessed by the system to be used for generating the non-fungible token, wherein
the generation data is
identified based on the received unique identifier, with reference to correspondence data between the unique identifier and the generation data, or
identified based on data that is received by the system to identify the generation data, and
the non-fungible token is generated by using at least the identified generation data.

4. A production system for a non-fungible token to be recorded on a blockchain, the production system being configured to execute a process comprising:
receiving a unique identifier possessed by an object;
determining whether or not the received unique identifier is an already-registered unique identifier that has been registered in the production system in advance; and
generating a non-fungible token having the unique identifier if the received unique identifier is determined to be the already-registered unique identifier, wherein
generating the non-fungible token is executing, by the production system, at least one of processes (1) and (2) as follows:
(1) a process including generating a non-fungible token having the unique identifier; and
(2) a process including generating a non-fungible token, such generating the non-fungible token including recording, on the blockchain or a computer outside the blockchain, correspondence between the non-fungible token and the unique identifier.

5. The production system according to claim 4, wherein the unique identifier is a unique identifier of an integrated circuit included in the object.

6. The production system according to claim 4, wherein
the process further comprises identifying generation data to be used for generating the non-fungible token, from among a plurality of material data that are possessed by the production system to be used for generating the non-fungible token,
the generation data is
identified based on the received unique identifier, with reference to correspondence data between the unique identifier and the generation data, or
identified based on data that is received by the production system to identify the generation data, and
the non-fungible token is generated by using at least the identified generation data.

7. A registration method executed by a system for registering a unique identifier, the system being configured to execute a generation process for generating a non-fungible token to be recorded on a blockchain, the registration method comprising:
receiving a unique identifier possessed by an object via a network; and
registering the received unique identifier as an already-registered unique identifier, wherein
the system is configured to execute the generation process upon receiving a unique identifier that is the same as the already-registered unique identifier, and
the generation process includes at least one of processes (1) and (2) as follows:
(1) a process including generating a non-fungible token having the unique identifier; and
(2) a process including generating a non-fungible token, such generating the non-fungible token including recording, on the blockchain or a computer outside the blockchain, correspondence between the non-fungible token and the unique identifier.

8. The registration method according to claim 7, wherein
the unique identifier is a unique identifier of an integrated circuit included in the object.

9. A system configured to execute a process comprising:
receiving a unique identifier possessed by an object, via a network;
registering the received unique identifier as an already-registered unique identifier; and
generating a non-fungible token to be recorded on a blockchain, upon receiving a unique identifier that is the same as the already-registered unique identifier, wherein
generating the non-fungible token is executing at least one of processes (1) and (2) as follows:
(1) a process including generating a non-fungible token having the unique identifier; and
(2) a process including generating a non-fungible token, such generating the non-fungible token including recording, on the blockchain or a computer outside the blockchain, correspondence between the non-fungible token and the unique identifier.

10. The system according to claim 9, wherein
the unique identifier is a unique identifier of an integrated circuit included in the object.

11. A production method for a combination product of an object and a non-fungible token recorded on a blockchain, the production method including steps executed by a non-fungible token production system,
the steps comprising:
receiving a unique identifier possessed by an object;
determining whether or not the received unique identifier is an already-registered unique identifier that has been registered in the non-fungible token production system in advance; and
generating a non-fungible token if the received unique identifier is determined to be the already-registered unique identifier, wherein
generating the non-fungible token is executing, by the production system, at least one of processes (1) and (2) as follows:
(1) a process including generating a non-fungible token having the unique identifier; and
(2) a process including generating a non-fungible token, such generating the non-fungible token including recording, on the blockchain or a computer outside the blockchain, correspondence between the non-fungible token and the unique identifier, and
the combination product includes the object and the non-fungible token.

12. The production method according to claim 11, wherein
the unique identifier is a unique identifier of an integrated circuit included in the object.
